(19) United States
(12) Patent Application Publication
(10) Pub. No.: US 2017/0170752 A1
(43) Pub. Date: Jun. 15, 2017

(54) Dielectric blade comb piston unlimited voltage generator, fusor and more

(71) Applicant: Yanming Wei, Mountain (CA)

(72) Inventor: Yanming Wei, Mountain (CA)

(21) Appl. No.: 15/267,122

(22) Filed: Sep. 15, 2016

(51) Int. Cl. H02N 11/00

(52) U.S. Cl. CPC H02N 11/002; H02N 11/006

(57) ABSTRACT

The electric vs. mechanic bi-directional power conversion application has been traditionally and asymmetrically favoring at magnetic element as energy caching and buffering bridge, e.g. the electric motors and generators that are also abstracted as electromechanical devices. The theory behind electromechanical devices is electrodynamics. Based on the fast development of high energy density dielectric materials, my inventions are to be a game changer: let electrical field alone to take the heavy duty of electromechanical utilities, and let “dielectrodynamics” replace electrodynamics. Of the most importance is the key limitless high voltage generator, which can cover full gamut of voltages from volts to kilovolts (KV), megavolts (MV), gigavolts (GV), teravolts (TV), and whatever we need, just provided necessary space occupancy and mechanic work are secured to assist dielectric piston or blades displacement. As the nature of such an electric power supply, it is fit for pulse application, such as Z-pinch, particle accelerator, nuclear ignition, fusion reactor, ornithopter etc. Civil application is also possible, such as harvest wind power, pulse heating even with overunity and so on, but regular non-pulse application needs further power smoothing or conversion.

It is the time of saying bye to Marx generator, rare earth magnetic materials, mile-size accelerator, country-size neutron spallation system and more, just cheerfully to embrace the epoch of powerful inexhaustible fusion energy and magnetic-free dielectrodynamic utilities.

### BACKGROUND OF INVENTIONS

The order of magnitude of voltage matters.

The current best choice of HV (High Voltage) supply, such as Marx generator, Van de Graaff generator, Tesla coil, the magnitude therein is mostly a few of MVs, none can march into the GV (gigavolt) domain, even nor most natural lightning.

It is reported that regular lightning can reach 100 MV and rarely 1 GV; and so far, the man-made highest voltage record is still hold by the Oak Ridge National Laboratory's landmark tandem electrostatic accelerator: 32 MV.

Although Marx generator no voltage limit in theory and no magnetic involvement, however it suffers from low efficiency in recharge and discharge, as worse as too many discrete high voltage capacitors occupying too much space, so as hopeless to achieve arbitrary high voltage.

Van de Graaff generators are of electrostatic type, and its ability of voltage anteing up is also frustrated by some factors, though it was the high voltage record keeper.

Tesla coil can also generate MV-level high AC (alternating current) voltage, however almost all super voltage applications are only in favor of DC (direct current), e.g. particle accelerator, unfortunately high voltage rated rectifier diodes are so few or expensive.

The scientific community is now focusing at the research of LTD (Linear Transformer Driver) high voltage (MV-level) and pulse high current (MA-level) generating technology, for example, the Sandia National Laboratory for her next Z-machine power supply.

As the LTD voltage adders need magnetic involvement in generation of huge power pulse, so it is doomed to face the cumbersome volume and expensive investment, perhaps more other technical difficulties, such as the unavoidable high parasitic inductance prohibiting the pulse width narrowing, etc.

Although the GeV and TeV accelerator can be built, however, a single DC power supply can never cope with it, instead of cascade RF powering, as well as the huge cost may be almost a financial black hole.

In the adventure of fusion, the magnetic inertial confinement Tokomak solution still struggles for the sustaining time and energy breakeven balance.

And almost all electromechanical devices, such as electric motors, generators, etc., still need the co-operation or interaction between the inherent electric fields and the induced or permanent magnetic fields.

If we can economically access GV-level or above electricity, or even if we can make midrange voltage utilities but with light weight feature resulted by elimination of expensive rare earth magnetic materials and heavy coppers, then a new world will emerge, especially both the fusion new epoch and the magnetic-free revolution of electromechanical equipments will loom and boom.

Motivated by such a great cause, my inventions are aimed by seeking feasible voltage-transforming methods to get rid of magnetic involvement and to break the prior record of high voltage as extensive as possible.

The shared play stage of electric and magnetic fields are now going to be monopolized by electric field only, can such a fresh electromechanical device or transformer still function as usual?

Yes, it can! After following brief introduction, I will show how to realize it in detail soon.

As electric energy can be stored either in pure electric field, or in pure magnetic field, or in hybrid of electric and magnetic fields, so even no longer available for the regular mode of electric and magnetic fields interplay together, the pristine electric-field-only device can still deal with energy transaction in circuit.

Intuitively dielectric-conditioned capacitors can cache electric energy or conduct energy transaction via discharge, and those behaviors and actions can be completed in pure electric field only without magnetic involvement, though dielectric media are insulators.

So in brief, it is proved true that dielectric materials can play the electric-field-only monologue in any utility application.

Now the only leftover concern is that whether the electric-field-only apparatus can be as powerful as the regular electric plus magnetic hybrid-field apparatus.

This concern will be thawed by the good news: in 2010, the Pennsylvania state university invented a new dielectric material which energy density is the top-rated and surpasses far more over the top affordable magnetic energy density. The publication of “DIELECTRIC BREAKDOWN OF ALKALI-FREE BOROALUMINOSILICATE GLASS THIN FILMS” heralds its coming.

Science Behind Inventions and Prior Arts

§1. Why is Magnetism-Involved High Voltage System Bottlenecked about MV-Level?

Magnetism-involved transformers always run on inductive effect where electromagnetic oscillation will happen, and oscillation results in AC in circuit, but for the extreme high voltage application, the DC is always preferred, so rectification should be done.

Diodes are applied for the purpose of rectification, and most diodes are made of semiconductors, the others vacuum tubes. As unidirectional passage electric component, a diode should withstand reverse voltage. For low voltage applications, never worry about it, but for extreme high voltage over specific threshold, reverse breakdown failure becomes a serious problem.

Diodes seem impossible or extremely difficult to withstand extreme high voltage larger than million volts. That is why the Tesla coil high voltage generator rarely used in particle accelerator, and that is also why the doomed bottleneck does exist for all magnetism-involved high voltage generator.

Of course, my magnetism-free high voltage generator has no such a bottleneck.

§2. Energy Density (ED) Matters.

For the industry-favored magnetic energy, the ED can be calculated via formula B²/(2μ), where B stands for magnetic strength, and μ permeability, 4π*10⁻⁷H/m for vacuum space. For the economic choice of max accessible B, e.g. B=2 Tesla, we have ED=1.6*10⁶ J/m³=1.6 MJ/m³.

For the dielectric space, the ED=∈∈₀E²/2, where E stands for electric field strength, ∈₀=vacuum permittivity=8.8.5*10⁻¹² F/m, ∈=relative dielectric constant to vacuum or air.

Taking E=3 MV/m as the breakdown limit of the regular atmosphere space, we can only get 40 J/m³, of course it is extreme shy to compare with magnetism.

But nowadays we have more and more better choices of dielectric materials to cache and buffer energy, even water is not too bad choice if its other demerit could be overcome, because of its high ∈=80 and high breakdown electric field E=60 MV/m, then ED=1.3 MJ/m³, on par with the aforementioned magnetic ED.

Other excellent dielectric materials: piezoelectric ceramic, ED=16 MJ/m³; AF45, invented by Pennsylvania university, ED=38.5 MJ/m³. Specially, AF45 is described by media ScienceDaily News as “Storing A Lightning Bolt In Glass For Portable Power”, because its breakdown limit can reach the incredible 1.2 GV/m!

In fact, energy density also reflects the specific pressure. This can be validated by checking the dimension in SI unit: J/m³=Nm/m³=N/m²=Pa, J—Joule, m—meter, N—Newton (1 kg=9.8N), Pa—Pascal.

The western favored pressure unit are bar and psi (pound per square inch), and 0.1 MPa=1bar=14.5 psi. So the abovementioned magnetic energy density is also the magnetic pressure 1.6 MPa=16bar=232 psi, as well as the air 40 Pa=0.0058 psi, the AF45 electric pressure 38.5 MPa=385bar=5582 psi. As a common sense, car tire is about 30 psi.

No wonder almost all power systems utilize magnetism, because its decent pressure 232 psi sounds strong enough for general dynamics!

Now that the new generation of dielectric materials possesses such a high electric pressure up to 5582 psi>>regular magnetic pressure 232 psi, why to hesitate to utilize them? The answer is because the current industry is not adept to make use of the electrostatic force.

My research shows that mechanical work can be efficiently converted to electrostatic energy with very little loss.

§3. How to Convert Mechanical Work into Electrostatic Energy?

Firstly, let us review the capacitor's capacitance and its energy storage.

For the simple parallel-plate capacitor, its capacitance C=∈∈₀A/d where A—the plate's area, d—the distance of plates, and its total stored energy=Volume*∈∈₀E²/2.

As the energy is proportional to square of electric field E, but linear with ∈, and E=V/d, V—voltage, so increasing V for higher energy density is more sensitive than increasing ∈.

By changing ∈ or E or volume, we can change the stored energy, but not great choice for altering material dielectric breakdown strength because of Eₘₐₓ always limited, except simply changing the voltage configuration under allowable Eₘₐₓ.

Changing ∈ can be done by mechanical displacement or temperature.

But the thermoelectric efficiency is quite low because of its high entropy, mostly <2%, even the most excellent mineral tetrahedrite <7%, so just forget temperature method.

Mechanic energy is low entropy and can be high efficiently converted to electric energy.

Luckily, we have a great range of ∈ to select; the highest ∈ even may hit the value of about 10¹⁰, e.g. the special formulated electrolyte materials in super capacitors, though their rated voltage is low.

Nowadays low cost high ∈ between 1000 and 100000 are used everywhere, such as the piezoelectric material in the cheap lighter. The regular high voltage rated solid material, e.g. PbMgNO₃+PbTiO₃, its high ∈=22600.

The easy mechanic energy carrier or transmitter is piston, however not necessarily the traditional cylindrical shape, in my dielectric media displacement inventions, the best shape of dielectric piston is thin slices or blades with rectangular transverse section.

By input mechanical work, we can change, or say, displace different materials inside the capacitor with great ∈ change. Theoretically, we can have equation:

Initial stored energy(state 1,Volume*∈₁∈₀E²/2)+Mechanic energy=Final stored energy(state 2,Volume*∈₂∈₀E²/2)+Friction loss.

It means the incipient medium with dielectric constant ∈₁ is displaced by medium ∈₂.

For simplification, we can omit the negligible friction loss, as friction reduction engineering methods are always available to choose and apply.

We do need initial energy pre-stored in the capacitor. If not, the dielectric material will be not pinched by any electrostatic force, so no way to input mechanic work to a loose dielectric medium.

The initial energy is provide by initial electric field or exciting voltage, in mimic of electric motor or generator jargon where exciting current is needed to initialize magnetic field if no permanent magnet is used.

We do not demand too much initial energy from the said exciting voltage, just like a motor or generator usually draws small fractional basic current for keeping basic exciting magnetic field.

Of course, special permanent electret material can be used, so no need to input it with initial energy, instead of collecting charges from free space, but hopeless of heavy duty.

For maximal mechanic energy harvest, we wish the final stored energy is far more than initial stored energy.

Usually, the higher the ∈, the higher polarization rate of bipolar moments, then more charges will be locked on the plates. Only by displacing higher ∈₂ medium with lower ∈₁ medium, then there are more unlocked free charges accumulated with potential to push to higher voltage, though the total locked and unlocked charges are conservative.

The higher the voltage increase, the more tightly the plates are pinched, then the more mechanic work you have to input, otherwise the medium is loose and free to move.

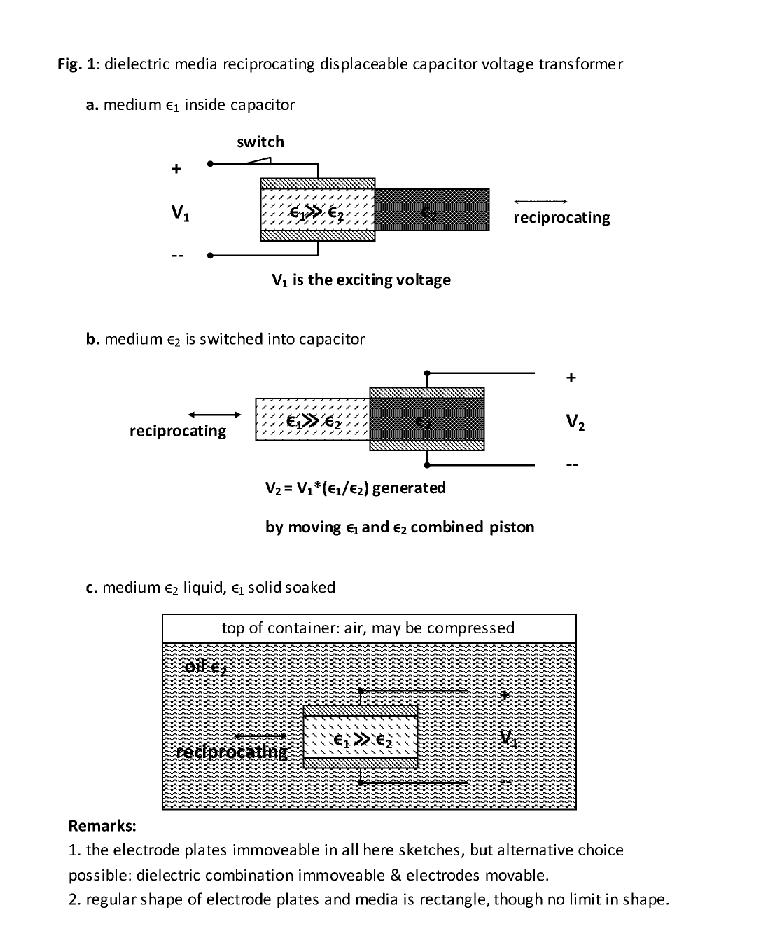

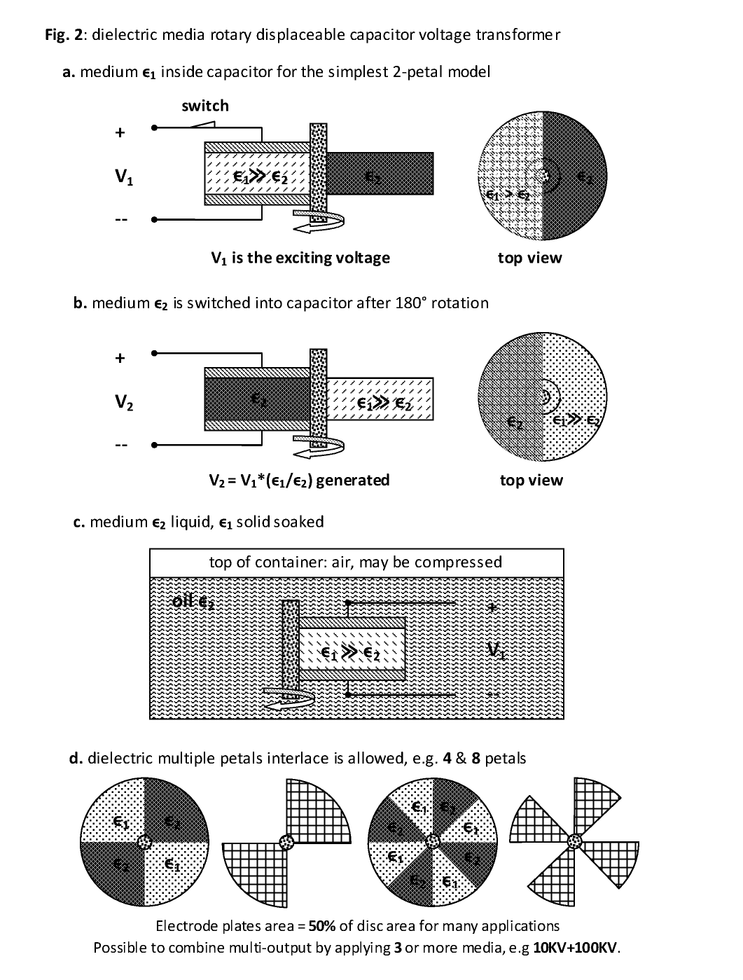

FIG. 1 intuitively shows dielectric media displaceable capacitor with HV generation.

§4. Work Stroke Analysis

So much for the qualitative description, now I quantitatively find how high the voltage can increase, and how many mechanic work is converted to electrostatic energy after displacement event, aka “work stroke” in mimic of internal combustion engine jargon.

As total charges conserve during displacement, and constant plate area, plate distance, volume, so does charge density CD, that means CD=∈₁∈₀E₁=∈₂∈₀E₂, E₁=V₁/d, E₂=V₂/d—electric field strengths of initial and final respectively, V₁, V₂—voltage of initial and final respectively.

Then we deduce that: V₂=(∈₁/∈₂)*V₁. For a reasonable design, ∈₁>>₂, so V₂>>V₁.

For convenience, hereafter, ∈₁ is always used to stand for high permittivity dielectric medium, and ∈₂ for low one, even this protocol is also applied universally in all figures.

As to the capacitance, C₁=∈₁∈₀A/d, C₂=∈₂∈₀A/d, so C₂=(∈₂/∈₁)*C₁, thus C₂<<C₁.

According to the formula of total energy of capacitor: the_final_energy=(C₂ V₂²)/2=(∈₂/∈₁)*C₁*[(∈₁/∈₂)*V_{1]}²/2=(∈₁/∈₂)*(C₁V₁²)/2=(∈₁/∈₂)*the_initial_energy.

Obviously, it is just what we expect: the_final_energy>>the_initial_energy.

Assuming friction is zero, then we have to input mechanic work:

[(∈₁/∈₂)−1]*the_initial_energy to cover the electrostatic energy increase. As ∈₁/∈₂>>1, then [(∈₁/∈₂)−1]*the_initial_energy≈(∈₁/∈₂)*the_initial_energy=the_final_energy, i.e., the final stored electrostatic energy is almost the total contributed mechanic work, and the initial energy, aka “exciting energy”, is just a small token!

Further, we can calculate the average force to drag the dielectric media.

Assume the capacitor is in shape of rectangle of width W and length L, to completely displace the initial medium ∈₁ along the length-wise, the mechanism should be exerted the average force:

F=[(∈₁/∈₂)−1]*the_initial_energy/L

Now, we understand that the higher ∈₁ medium is setup to work under low voltage for exciting initial electrostatic field, and the lower ∈₂ medium as the energy real bearer working under high voltage, and then we also understand that only the low ∈₂ medium's maximum energy density is utilized, but the capability of high ∈₁ medium's energy density is under-employed because of its purpose of initial excitation electric field with small token energy.

Someone may be interested in the transition of displacement. Now, let's deal with it.

We use χ to stand for the percentage of transition completeness, and then value 1 or 100% means medium ∈₁ is totally displaced by ∈₂. So the transient voltage, capacitance, and accumulated energy all are the functions of the parameter χ.

So long as we recognize charge conserve restriction, following functions can be obtained:

The transient capacitance function: C(χ)=C₁*[∈₁(1−χ)+∈₂χ]/∈₁

The transient voltage function: V(χ)=V₁*∈₁/[∈₁(1−χ)+∈₂χ]

The transient energy function:

the_transient_energy(χ)=the_initial_energy*∈₁/[∈₁(1−χ)+∈₂χ]

Substituting χ=1, we get the same results of the final state with the earlier expressions.

If drawing out the respective function graphs, we can find: only capacitance is linear function, the voltage and energy are both non-linear with very steep curve while χ approaching 100%. That means no big force is needed during incipient displacement action, but strong force at ending.

FIG. 4 shows the waveform of full loaded voltage output. It hints that the voltage change between the capacitor electrodes is nonlinearly related with dielectric displacement.

In brief, when dielectric medium in capacitor is switched from high permittivity ∈₁ to low one ∈₂, such a displacement needs input of mechanic energy, and in turn this mechanic energy will be converted to electrostatic energy, thus voltage will be multiplied greatly by ∈₁/∈₂, in spite that no charging current follow is infused to the capacitor.

§5. Reset Stroke Analysis

For a utility, it needs to work cycle by cycle constantly. So when the “work stroke” finished, we see the high voltage, and then need re-start the next cycle.

I define: the reset stroke is referred to the “reverse” displacement that high dielectric constant medium enters the capacitor after the low one goes out of the capacitor.

Obviously if the high voltage energy is not taken away, or say, consumed elsewhere, then no need to re-input mechanic energy for reset of dielectric medium ∈₁, because the powerful resilient force will act, and the media combination strip will be accelerated backwards, that means the stored electrostatic energy will be reversed to mechanic energy, and it may be not what we desired.

If the generated electric energy is not used, then the reset max velocity Ve of the media movement can be resolved by energy conservation law:

0.5*m*Ve*Ve=the_initial_energy*[(∈₁/∈₂)−1],m—the mass of the dielectric blades.

Ve={2*the_initial_energy*[(∈₁/∈₂)−1]/m}^{0.5}

By holding back the media reset, and let the media slowly finish the reset stroke, we can also prevent the media from gaining kinetic energy, but it will result in higher voltage (∈₁/∈₂)^{0.5}*V₁, V₁ is the original exciting voltage.

If always idling the output and holding back during reset stroke, after the next cycle work stroke, new voltage is (∈₁/∈₂)^{1.5}*V₁, and if so on, the next cycle reset voltage (∈₁/∈₂)*V₁, this indicates a gradually augmented tooth-shape voltage curve in timeline.

For the said tooth-shape voltage situation, there is a set of general formula to calculate the nth cycle peak voltage and reset voltage as follows:

Vₙ₋ₚₑₐₖ=V₁*(∈₁/∈₂)^{(n+1)/2}, and Vₙ₋ᵣₑₛₑₜ=V₁*(∈₁/∈₂)^{n/2}

Unless special design, otherwise, the above run mode will damage the media if voltage is over the breakdown voltage.

In fact, of the two dielectric materials pair, it is the vulnerable one with lesser breakdown electric field strength that determines system maximal attainable voltage.

Usually even the applied field exceeding the limit, breakdown event can still not occur if the stay time is too short because electron avalanche is an accruing process, so it's possible to “overclock” dielectric materials for extra energy storage.

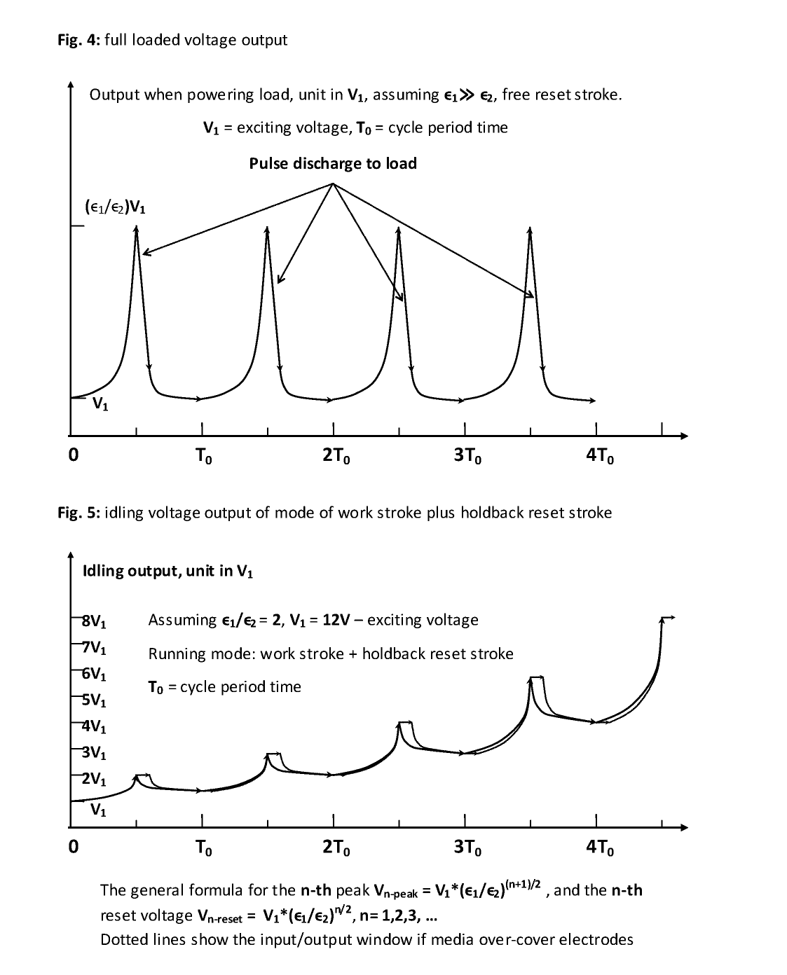

FIG. 5 shows the idling voltage output of mode of work stroke plus holdback reset stroke.

If the high voltage energy is totally consumed or transferred elsewhere, i.e. V₂=0, then reset to ∈₁ may need basic minimal input of mechanic energy to overcome friction and keep reasonable retraction velocity unless the type is not reciprocal but rotary generator with usable remnant inertial energy because no cached electric energy can assist, but the token electric field should be regenerated by low exciting voltage for the next cycle to run.

However we can take accurate control to the output high voltage discharge in order to omit the tedious re-excitation or possible minimal mechanic energy input, it means that only one time is necessary to excite initial field during uptime. In this case the post-discharge remaining voltage should keep the remaining energy equal to the initial excitation energy:

Volume*∈₁∈₀E₁²/2=Volume*∈₂∈₀Eᵣₑₘₐᵢₙ²/2

i.e. Vᵣₑₘₐᵢₙ=V₁*(∈₁/∈₂)^{0.5}

If the remaining voltage is less than the Vᵣₑₘₐᵢₙ, it is necessary to partially recharge the initial voltage to the same V₁, if every cycle needs same performance.

In fact, the initial energy just a small token, re-exciting is not a big deal, so never mind to fully discharge the high voltage output if accurate control is difficult.

If partial output consumption does occur but the leftover voltage is still greater than Vᵣₑₘₐᵢₙ, perhaps it is a good idea to dump the remained small energy until Vᵣₑₘₐᵢₙ is seen (or 0 if not care about re-excitation) by simply short connecting the positive and negative terminals for smooth reset.

By comparison, the conventional electromechanical device even eats more mechanic energy by magnetic material eddy current heating.

The most spectacular output energy take-away method may be the Z-pinch discharge; at least, that is the preferred choice for Sandia National Lab.

From above studying, we can conclude that the high voltage output is limitless, GV (Gagavolt), TV (Teravolt), even PV (Petavolt) are never a dream, provided only the dielectric breakdown strength Eₘₐₓ should be respected, because V=Eₘₐₓ*d and the parameter of distance d unlimited, as long as space is not restrained.

§6. Geometry conflict Unlimited high voltage output sounds good, but C=∈₂∈₀A/d is never unconditional true and accurate, unless we can try our best to let the plate area A>>d*d.

However assuring A>>d*d may spoil our unlimited voltage V=Eₘₐₓ*d, because the former needs parameter d as short as possible, but the latter d as long as possible.

This embarrassment can be overcome by inserting a large number of intermediate plates as many as necessary, and then the whole capacitor is equivalent to a series of cascading capacitors. For uniform insertion of N plates, every single element capacitor has equal thickness d₀=d/N.

Because of the similarity between the dielectric slices and blades, sometimes the dielectric piston is also figuratively referred to dielectric blade comb piston.

Do more or less intermediate plates matter? The answer is: It depends.

The original purpose to insert enough intermediate plates is to meet a basic condition A>>d₀*d₀, but if the element capacitor's thickness d₀ is too tiny, then it will make the breakdown strength Eₘₐₓ increase many folds, and only when thicker than a threshold value, then the Eₘₐₓ seems constant.

For example, the DuPont's brand Mylar is just such a special: if thickness >14 mil or 356 μm, then Eₘₐₓ=80 MV/m, else if thickness=0.25 mil, then Eₘₐₓ=800 MV/m, else the thinner, the higher.

As the max energy for a given constant volume=Volume*∈∈₀Eₘₐₓ²/2, so if the inserted number N is reasonable then the energy capacity has nothing to do with insertion number N, else if too dense the energy capacity will be multiplied because Eₘₐₓ will increase if spacing very short.

While the count N intermediate media blades are inserted, to separate dielectric blades, the same insertion count of intermediate electrode plates are also needed.

There are many tactics of wiring the inserted electrode plates, such as parallel mode, cascade mode, or mix mode.

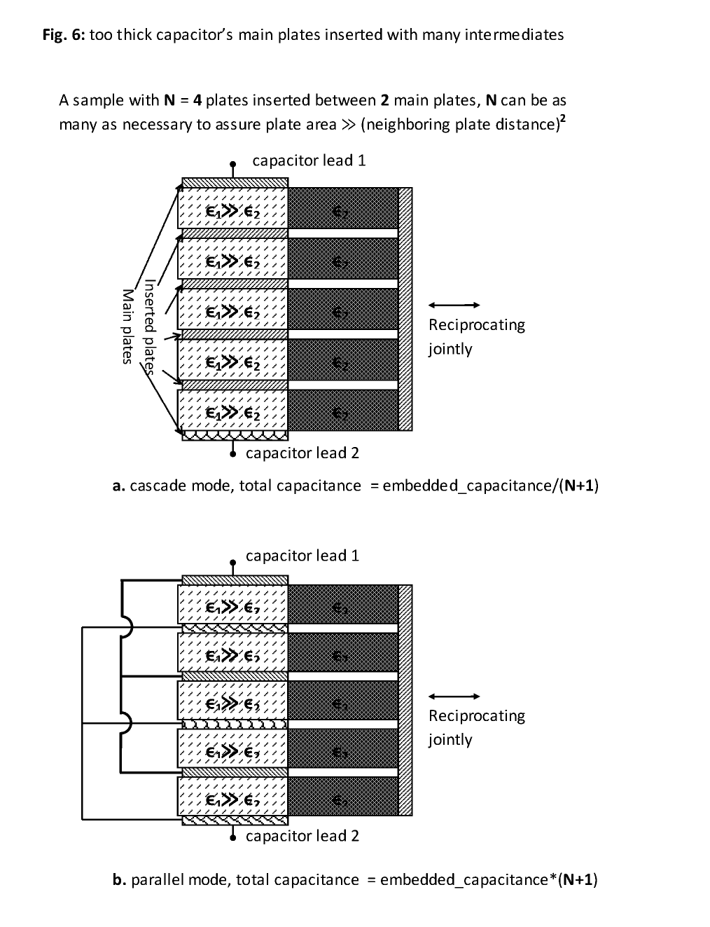

FIG. 6 sketchingly teachs how to stuff thick capacitor with many very thin dielectric laminating blades, and combine all blades into a drivable comb.

It is just a sample with N=4 plates inserted between 2 main plates, N can be as many as necessary to assure plate area>>(neighboring plate distance)².

When extreme high voltage is pursued, it is preferred to wire in cascade mode that nothing wiring job is required in fact. In this case, the whole capacitance equals the embedded cell capacitor's capacitance divided by total cell number, i.e. C_{grand}=C_{cell}/N, the mode illustration can be seen in FIG. 6a: cascade mode.

When higher current is pursued, it is preferred to wire in parallel mode that every other one electrode plate is connected together, just like the air gap tunable capacitors in old school style radio receivers. In this case, the whole capacitance equals the embedded cell capacitor's capacitance multiplied by total cell number, i.e. C_{grand}=C_{cell}*N, the mode illustration can be seen in FIG. 6b: parallel mode.

As to the mix mode that can just be the simple mix of cascade and parallel mode, most likely it is for midrange voltage goal.

Although the deployment of tiny thickness element capacitors can increase the energy density, the mechanic strength of every individual media combination slice may be deteriorated, especially, the thinner the material, the greater intolerable deformation under stretch stress and the quicker increase of undesired friction, so careful trade-off should be considered.

§7. Special Driving Mechanism for Dense Insertion of Intermediate Plates

As to how to drag-out or push-in the combination dielectric strips or slabs or blades, it is not a scientific issue, but a technical or engineering issue.

Assuming the two dielectric media both solid, we can fix adjacently the media of same size on a common substrate strip, and then make the strip drivable, but the affect of substrate should be considered.

For N-plate inserted system, all parallel media-carrier strips should be joined together to a rigid lead bar, and then total driving force is distributed to dielectric pieces uniformly.

As the speed of work stroke does not matter, we can use gear system or winch or whatever fast or slow means to drive the displacement for better torque or force match. For example, the high voltage system can either be hand-powered via winch, or wind-power, or regular electric motor, or fuel engine.

For Z-pinch application, we wish the discharge pulse as narrow as possible, however it has no relation to the high voltage accumulation speed. That is why multiple mechanic drive still allowed. Only for applications of high ratio of duty cycle, e.g. fusion reactor, we need speed the mechanic driving response time.

For friction reduction, all metal plates and media surface should be polished as mirrors. Some dielectric media are innately low friction, e.g. Teflon (Polytetrafluoroethylene), just consider it if its dielectric properties meet design requirements.

§8. What if One Dielectric Medium is Liquid?

Solid dielectric media are never the exclusive choice, but at least one of the pair media should be solid for convenience of drive and separation of media.

When one of the media is liquid, the counterpart medium is better to be soaked inside to take advantage of gravity or hydraulic pressure induced automatic displacement.

Some liquid dielectric media have high breakdown strength and decent ∈, e.g. transformer oil: ∈=4.5, Eₘₐₓ>110 MV/m, specific weight 900 Kg/m³, also good thermal conductivity and arc quenching ability, so just choose it if possible.

There are some special phenomena with liquid media: bubble and cavitation. It is better to avoid the occurrence because dielectric properties will be changed if too many embedded bubbles, also the cavitation is harmful and can corrode mechanic parts, despite that cavitation may induce nuclear fusion too, anyway not significant.

Not only liquid, but also gas phase can be considered if it can feature high breakdown electric field strength. Unfortunately all gas media have lower breakdown strength compared with solid and liquid.

§9. Why Pulse Output?

During increase of voltage, i.e. switching from high dielectric permittivity to low one, any load will be “toxic”, because the load will draw electric current, and then depress the accruement of voltage, also cap the absorption of mechanic energy; only therein idling can maximize the energy conversion from mechanic to electric.

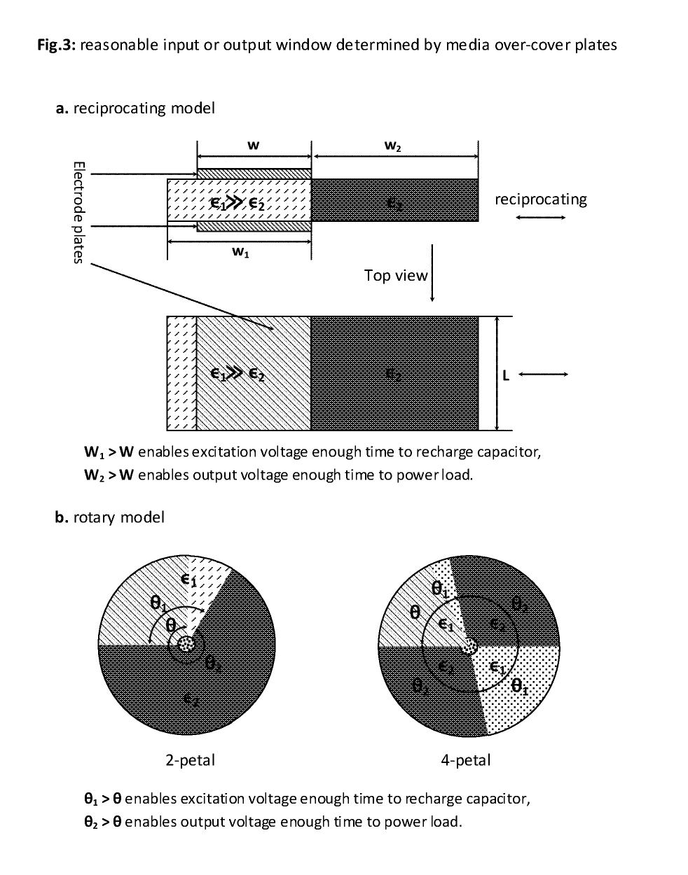

Thus, there should be a switch to disconnect the load from the capacitor while in action of displacement, and then reconnect during phase of “rest stay” aka “step stay” while same medium is U-turning or arc-sweeping inside the margin which width equals to the difference value between the medium and electrode plates, as illustrated in the FIG. 3.

For reciprocal model, W₁>W enables excitation voltage enough time to recharge capacitor, and W₂>W enables output voltage enough time to power load.

For rotary model, θ₁>θ enables excitation voltage enough time to recharge capacitor, and θ₂>θ enables output voltage enough time to power load.

If δW=Wᵢ−W or δθ=θᵢ−θ(i=1 or 2) too small, even close to zero, the rest stay width, or pulse width of recharge or discharge could be very or extreme narrow, by specially arranging the load, it is possible to simulate the explosive effect, such as Z-pinch setting, water explosion, etc.

Generally speaking, the specific power will be enlarged to W/δW or θ/δθ times at least.

§10. Design Exercise

Assuming we need to build a 1 GV generator for particle accelerator, and selecting transformer oil with dielectric constant ∈=4.5 as primary electrostatic energy storage, the soaked ceramic with high dielectric constant δ=22600 for the initial exciting field medium, let us try to scale the generator in 3 different energy order of magnitude.

The exciting voltage=(∈₂/∈₁)*V₂=(4.5/22600)*1000,000,000V=200,000V=200 KV.

Transformer oil can withstand 100 MV/m, so for 1 GV output, we need d=10 m length at least. With above given data, we calculate the energy density, and get 0.22 MJ/m³.

For an ideal capacitor, the plate area A should be far larger than d*d=100 square meter. If the area is 100 times d*d, then 10000 m² area of every single plate should be assured, of course, that is obviously an impossible monster.

To avoid above ridiculous geometry, we have to insert lots of plates inside the 10 m distance. Assuming N=1000 pieces of plates inserted, i.e. d₀=d/1000=10 mm thickness for every single cascading element sub-capacitor.

For easy estimation, just assuming the plate shape is square rectangle that means equal size for all 4 sides. To meet A>>d₀*d₀, e.g. reasonable A=25*d₀*d₀, then we find the minimal plate size should be at least 50 mm×50 mm or 5 cm×5 cm.

For such a basic size, the minimal energy storage equals energy density multiplied by volume: 0.05 m*0.05 m*10 m*0.22 MJ/m³=5.5 KJ=5500 J.

The next two scaling of energy order of magnitude are 550 KJ and 55 MJ which respective plate sizes are 50 cm×50 cm and 5 m×5 m. Any of those can be reasonably housed in a big commercial building.

As to the mechanic driving force, for the basic 5 cm×5 cm×10 m capacitor column with 1000 pieces plates insertion, the total displacement force is F=5500 J/0.05 m=110000N≈11000 Kg=11 tonnes. Every element ceramic slice will subject to 11000/1000=11 Kg.

Scaling to 50 cm×50 cm×10 m embodiment, we get 110 tonnes for total, and 110 Kg for single piece; to 5 m×5 m×10 m, 1100 tonnes for total, and 1.1 tonnes for single piece.

The 55 MJ is about the energy amount of one kilogram gasoline, and such a system is just the next pursue of Sandia Lab with their prediction of fusion breakeven dream.

If the said equivalent 1 Kg gasoline is combusted by a car of fuel economy 10 liters per 100 km, the car can run about 10 km distance, within about 6 minutes if at 100 km/h.

For the 55 MJ jumble model, perhaps a heavy duty diesel engine of 300 HP (horsepower) is needed for providing the huge 1100 tonnes drive force to dielectric piston.

And maybe significant charging time between minutes and hour is needed to infuse the 1 kg gasoline equivalent energy to the huge capacitor, depending on how fast the operator expects. If imagining the aforementioned car analogue calculation, 6 minutes seems a reasonable speculation.

Also, not to worry about this long time high voltage rise time, it is not the pulse width. Only when the HV output is discharging to a load, it makes sense to treat discharge time as pulse width and the 100 ns to 200 ns for Z-pinch is desperately desired.

Total transformer oil weights are 0.05*0.05*10*900 Kg=22.5 Kg, 2250 Kg, and 225 tonnes respectively for above 3 dimensional scaling cases. Of course, when the solid dielectric medium is fully inside capacitor, all the oil must be displaced out, so a quasi same size oil tank is needed to hold the displaced oil, and be pumped back when dielectric piston is lifted.

For all scaling models, the exciting voltage=(∈₂/∈₁)*V₂=200 KV is same, but exciting energy=(∈₁/∈₂)*output_energy is different: 1.1 J, 110 J, 11 KJ respectively for 5.5 KJ, 550 KJ, 55 MJ.

The equivalent capacitance in HV status equals: 2*rated_energy/rated_voltage², i.e. 0.011 pF, 1.1 pF, 110 pF respectively for 5.5 KJ, 550 KJ, 55 MJ.

All the aforementioned 3 scaling models have same length of 10 meters, but it is too ideal because the grand total of thickness of all inserted intermediate plates is ignored.

Now, we need consider dimension correction to address above concern. Although I assume the count of the intermediate metal plates=1000 pieces, anyway, it seems arbitrary because the purpose-oriented condition A>>d₀*d₀ is fuzzy and flexible, however, regarding the double of ideal length as last physical length may be a reasonable assumption.

And because it is not the metal plates but the dielectric media that bear the energy, so whatever the last correction is applied, all never affect other parameters estimation exception the embodiment total length may be significantly larger than the ideal 10 m.

Is the size too huge? Not really!

It is so pretty if compared with Sandia Lab's LTD-based 1 petawatt proposed model that features a super size of 104 meters diameter and voltage less than 5.4 MV, as per the Wikipedia literature under key word Z_Pulsed_Power_Facility.

It should be more glory if compared to the 1000 meters long 1 GeV LENAC accelerator of the Spallation Neutron Source Center in Oak Ridge National Lab.

If not select transformer oil, but the advanced AF45 special glass, we can further reduce the dimension. Because AF45 features a super strong dielectric strength of 1.2 GV/m, so that only 1 meter long can withstand the wanted 1 GV, further, perhaps it is possible to build a desktop or benchtop electrostatic GV-level particle accelerator!

Even conservatively stick to the same with or a little bit higher than the voltage level that the prior art can achieve, there is no need of recalculation of all dimensions except electric parameters, because previous dimension calculation is based on energy density.

Assuming the said Sandia's LTD-based plan of 5.4 MV is to be implemented via this invention, the exciting voltage=(∈₂/∈₁)*V₂=(4.5/22600)*5,400,000V=1075V, such a low voltage can be easily realized by whatever cheap means.

Again the equivalent capacitance in HV status equals: 2*rated_energy/rated_voltage², i.e. 0.38 nF, 37.7 nF, 3.8 μF respectively for 5.5 KJ, 550 KJ, 55 MJ systems.

The wiring mode of inner inserted electrode plates is no longer the pure cascading of cell capacitors, but a mix of cascading and paralleling model to reach the 5.4 MV compromised voltage.

§11. What is the Difference Between Dielectric Pinch and Z-Pinch?

In short, Z-pinch is caused by magnetic field pinch force, but dielectric pinch is caused by pure electric field force.

By applying huge electric current, such as million amperes, in conductor wire Z-pinch configuration, strong magnetic field will be induced on the normal plane perpendicular to current direction, thus large centripetal force is exerted around the conductor.

Dielectric pinch is caused directly by extreme strong electric field with absence of current. The direction of pinch force is just parallel to the electric field.

The relationship between electricity and magnetism is analogue to hen and egg, so dielectric pinch is more primitive than Z-pinch, and more energy efficient because of no charges flow aka “electric current”.

Z-pinch huge current draw will instantly disintegrate atoms, and spread instable plasma of high kinetic energy baryon and lepton, lead to extreme temperature on narrow Z-axis.

In contrast, dielectric pinch draws zero current and generates extreme contraction pressure loved by fusion without thermal dissipation prior to breakdown, though wake breakdown can happen with companion of fusion products.

Because prior arts incapable to generate the extreme high voltage that can commeasure with atom inner electric field strength, so that electrostatic pinch force is too weak to be noticed, hence its great potential in fusion is completely ignored until now.

§12. How Strong Electric Field should be at Least for Crush Nuclei?

The simplest and lightest atom is hydrogen, and its electric field at any point of the electron orbit can be calculated via: e/(4π∈₀*a₀*a₀)=5.15*10¹¹V/m=515 GV/m, where e—standard electron charge, a₀—Bohr radius; similarly, for the heaviest atom uranium, the innermost K shell electric field is about 4*10¹⁷V/m=4*10⁸ GV/m.

So only if the external field is commeasurable with the level of 515 GV/m, may it be possible to crush a hydrogen or deuterium or tritium atom.

It is not difficult to sustain a 1 GV/m for some special material, e.g. the AF45 glass, but over that strength, almost all media will be broken-down, and damaged in atomic or molecular level, but not nuclear level.

For human being's ambition to explore the nuclear energy, we only care about the tool's (the high voltage generator) dielectric breakdown, but do not care about the fuel's dielectric breakdown, so just bravely apply the highest obtainable limitless voltage to the dielectric fuel, so as to reach the strong nucleus-crushable electric field strength.

The deuterium+tritium is the most realizable nuclear fusion reaction:

D+T=He⁴(3.5 MeV)+n(14.1 MeV)

The best temperature for above is 60 KeV, and its max cross section is circa 5 barns, hence we can get the ignition critical pressure is about 140Mbar≈1.4*10¹³ Pa.

As the electric field induced pressure is 0.5*∈*∈₀*E², the higher ∈, the lower E will be. Given the D+T mixture ∈≈1, we can calculate the critical electric field strength E_{D+T} via:

0.5*∈*∈₀*E_{D+T}²=1.4*10¹³ Pa

E_{D+T}=1800 GV/m, about 3.5 times of hydrogen orbit electric field strength 515 GV/m.

Harsh to reach above ignition criteria? No problem, we can alleviate it by chemical synthesis of dielectric compound with super ∈>>1 which contains the fuel D+T. Usually the metal hydride is preferred.

If the dielectric constant of synthesized fuel compound can be higher in million times than D+T mix gas, then the critical electric field strength will reduce 1000 times to 1.8 GV/m. Now it is easier to realize with my super voltage generator.

The liquid cryogenic or ice D+T bulk has higher dielectric constant than the D+T gas, so even you don't know how to synthesize high dielectric compound, just simply use D+T ice to ignite the fusion reaction, even heavy water possible.

It is said that the ideal vacuum can withstand the strongest electric field as high as Schwinger limit: 1.3*10¹⁸V/m, over that limit, the probability of generation of pair of electron and position will be greatly increased.

Although Schwinger limit has never been realized or closely approached by mankind, out of curiosity I can joyfully use the aforementioned regular formula to get the Schwinger energy density: astonishing 7.47*10²⁴ J/m³. Perhaps it is not a dream to realize it via this invention of limitless high voltage generator.

Of course, the said critical ignition pressure 140Mbar can also be triggered by extreme strong magnetic strength, though it's not the focus of this invention, the answer can be gotten from following equation:

0.5*B_{D+T}*B_{D+T}/μ₀=1.4*10¹³,μ₀=4π*10⁻⁷H/m, the vacuum permeability,

then B_{D+T}≈5000 T(Tesla).

It is well known that the current super strong neodymium permanent magnet can only reach above 2 T, so the calculated 5000 T seems a challenging tough objective to achieve.

§13. About the Criteria of Z-Pinch Fusion Energy Generation Breakeven

According to the Sandia Lab's science paper, their highest neutron yield of Z-pinch can reach 60 million neutrons per joule energy input.

As no neutron will be wasted, even unluckily not captured by any nucleus, it can release at least 0.78 MeV via β decay to proton within about 15 minutes.

Almost all neutrons can be captured after cooling to room temperature, and every capture event can produce energy about 7 MeV in average by recoil or gamma photons.

If well designed, the ensuing events can continue to generate energy by beta or alpha decay or delayed other events, during which, about 8 MeV can be reasonably assumed. Here the ensuing fission event is ruled out, unless the resource limited fission isotope U-235 is used, though its energy can be many folds higher.

So, total 15 MeV in average can be optimistically induced by one thermal neutron.

No neutron is released in cold state, if Z-pinch induces D+T reaction, extra innate 17.6 MeV should be added to the total, else if D+D then 4 MeV, so total is 15+17.6=32.6 MeV per neutron for the former, and 15+4=19 MeV for the latter.

Now it is ready to assess Sandia Lab's potential efficiency of nuclear energy generation:

For simplicity and rough estimation, take 30 MeV per neutron, we find:

The specific efficiency=output/input=

(60*10⁶)*(30*10⁶)*(1.602*10⁻¹⁹)J/1J≈0.0003=0.03%

The result means 99.97% input is converted to non-nuclear dissipation, and obviously indicates the efficiency is far away to the breakeven.

For meaningful breakeven, the nuclear energy output should be far more than or commeasurable to the conventional thermal dissipation.

If the neutron yield can be increased to 1000 times of current quote 60 million per joule, then the specific efficiency will be 30%, i.e. the overunity=1.3, it hence exhibits some commercial potential.

The deep Z-pinch research shows the neutron yield grows cubically as a function of the electric current. So if the prior Z-pinch max current can be increased 10 times, then the increased 1000 times neutron yields can make breakeven point occur.

According to ohm's law, the best direct way of increasing current is to increase voltage as high as possible, so increasing current Z-pinch voltage to 10 times above can theoretically meet the breakeven condition, however unluckily prior art of high voltage generation already touches the ceiling.

Even no barrier of increase voltage to whatever times, we prefer to shun Z-pinch and incline to dielectric pinch even its much higher demanding voltage than Z-pinch, as Z-pinch is inferior to dielectric pinch because of its high thermal dissipation.

§14. Why Accelerator-Based Fusion Most Likely Hopeless of Breakeven?

Nowadays high energy physics can accelerate particles to the energy order of magnitude GeV even TeV, however it will consume huge input energy, because the accelerated relativistic particles usually fly in almost light speed.

It is only good for special purposes such as medical isotopes synthesis, educational demonstration etc., and never a decent choice for commercial energy generation, because the extreme high input does spoil the breakeven.

From the view of aforementioned analysis, the extreme high voltage power supply is capable to catalyze fusion reaction and reach breakeven point, because there is no particles long distance relativistic speeding, but local extreme pinching in situ, so the input energy is mainly and efficiently used for overcoming the coulomb barrier.

Although prior art GeV/TeV acceleration realizable, it does not imply GV or TV voltage order of magnitude power supply a reality, because the said GeV/TeV is not acquired via direct applying high voltage to the main 2 electrodes, but via bunching RF cavities or other means. So it is not feasible to modify it to adapt commercial reactor.

§15. Review on Prior Fusors

A fusor is a device that uses an electric field to heat ions to conditions suitable for nuclear fusion.

Philo Farnsworth is the original designer, and many improvements have been done by other scientists in past decades. The famous is the Polywell version of Robert Bussard.

Basically those fusors use the low pressure fuel deuterium or mix of deuterium and tritium in gas phase. Although fuel is dielectric media, however the Paschen's law undercuts significantly the dielectric strength, then the dielectric media have to be used in conductor state with the transient fuel charged particles accelerated up to 100 KeV for higher cross section of wanted fusion reaction. This obviously falls in the accelerator-based fusion category that dooms low efficiency and hopeless to achieve breakeven.

Do not be obsessed by Dr. Brian Naranjo's observation of nuclear fusion driven by a pyroelectric crystal. He just used the dielectric material LiTaO₃ as HV generator of circa 100 KV to accelerate deuteron, no substantial difference with the regular fusor.

Perhaps historically the most relevant experiment should be credited to Dr. Dougar Jabon's team. In 1997, they published a paper: “Catalitically Induced D-D Fusion in Ferroelectrics”. In their experiment, LiTaO₃ crystal saturately adsorbs deuterium, so the enhanced neutron flux is caused by dielectric pinch though breakeven still far away.

Once again to reiterate, only assisted by extreme high voltage, the gleam of hope is at the dielectric pinch on the special designed fuel with high dielectric constant and high breakdown strength D+T contained new compound, especially hydride compound, e.g. lithium hydride (LiH) ∈=13.

Also I am not optimistic upon the tokomak based ITER project.

§16. Achieving Breakeven with Non-Nuclear Pre-Overunity Stage

Because the dielectric piston needs mechanic force to drive, and coincidently there is an overunity mechanism that can boost the whole system performance: water arc explosion. More amazingly the water droplet velocity can reach as high as 1 km/s, almost 3 Mach number!

On Sep. 8, 2000, the Journal of Plasma Physics published a profound paper: “Arc-liberated chemical energy exceeds electrical input energy” authored by the team of famous scientist Dr. Peter Graneau et al.

The authors reported the experiment results of overunity up to 1.6, or say, the output kinetic energy can be 60% more than input electric energy of 12 KV discharge.

The other scientists all over the world conducted different experiments after Graneau, most duplicate experiments was successful, and easily reach 2-folds overunity.

It seems this overunity is easier to achieve than the Z-pinch.

As to the underlying scientific rationale, the scientific community is still arguing. In my point of view, none of current explanation is pertinent, such as hydrogen oxygen gas HHO explosion theory, zero point vacuum energy theory, etc.

In fact, the principle is that high strength electric field rectifies the bipolar orientation of water molecules, hence depresses the thermal random Brownian motion, and then all the kinetic energy carried on the trimmed off directions are overlaid on the rectified direction, so the water's temperature is lowered and explosion energy equals to the sum of input electric energy plus water reduced thermal energy, then overunity occurs.

After explosion, the projectile water need re-absorb thermal energy from ambient to re-attain thermal balance, so in a sense, it prospects a cool future to harvest atmosphere background heat energy, anyway the ultimate source of the background heat comes from the solar eternal cooking on our earth.

The Graneau's experimental voltage 12 KV is too low if compared with fusion needed GV-level generator, and nowhere to find MV-level water explosion data, except the immersed tungsten conductor wires Z-pinch data that exhibits super strong shockwave.

Compared with KV-level water explosion, probably better overunity can be seen for GV-level, because such a high field level may trigger fusion energy.

At last, combining the non-nuclear overunity and nuclear overunity, should enables the fusion energy generation more feasible.

§17. Which Parameter More Important for Voltage and Energy?

As per the aforementioned design exercise, there is a huge difference in manufacture dimension and cost for the same 1 GV output but with different energy capacity.

For the 5.5 KJ model, the size is only 5 cm×5 cm×(10^{˜}20) m, almost portable or benchtop mountable, but for 55 MJ model, a jumble monster size: 5 m×5 m×(10^{˜}20) m, unimaginable cost!

To crush the lightest hydrogen, we need at least 515 GV/m, and no special requirement to the power supply energy capacity.

With higher voltage, of course by Ohm's law, the higher pulse current can be reached, though the pulse width will be shortened if energy capacity is low.

The greedy demand to high energy capacity may only come for laboratory research, such as Z-pinch limit, or whatever crotchet experiment.

In conclusion, it is the high voltage that is paramount, not the energy capacity. By reducing unnecessary energy capacity, the saved space and cost can make output higher and higher, even teravolt affordable.

§18. Is this Invention Possible to be Utilized in Civil Application?

Sure, it can be.

Generally speaking, the civil applications do not need too high voltage.

By select two media with reasonable differential value of dielectric constants, we can limit the (∈₁/∈₂)*V₁ not so aggressively high. Even though the advantage of high energy density not fully exploited, it still does not matter, because we can change mechanic movement frequency of media displacement, then a realistic specific power can be implemented to power the civil electrical appliances.

For example, by setting ∈₁/∈₂=10, we can let a small regular rechargeable lead-acid battery with voltage V₁=12 VDC be the initial electric field exciter, and harvest the wind power by high-rise turbine to generate the homestead hydro output V₂=120 VDC. After DC-AC inverter, we can combine it to the commercial grid power, and power any regular electrical appliance.

Even ∈₁/∈₂ still in high ratio configuration, by using a diode, a qualified zener diode, and a high capacitance electrolytic capacitor, to limit the allowed voltage, then we can also reach the same effect with low ∈₁/∈₂ ratio.

So, the civil application is never a problem with this invention.

Another useful application is used as pulse power supply that can power ornithopters.

Based on this root invention, there are more civil applications waiting for exploration.

§19. Is Generator-Motor Double-Duty Possible with a Device Based on this Invention?

Now that civil application possible, the industry will be amazed at the potentials.

It is well known that most regular magnetism-involved electric motors can be used as generator by changing the wiring, and vice versa, though the manufacturer's preset purpose either as a generator or a motor, never both.

As an analogy, the pure electric field involved generator can also be used as electric motor by minor re-configuration, and vice versa.

However, single-purposed products always have higher effect and best performance.

If well designed, dielectric displacement motor can exhibit huge torque far higher than the regular magnetic-based motors, because dielectric motor can withstand extreme high voltage pulse, not like regular motors with strict voltage rating.

The gorgeous vista includes but not limits to: excellent torque output, saving torque converter or gear reducer or transmission, smooth varying speed, easy change of rotation direction, etc.

Unfortunately, the existing industrial 3-phase or household single phase electric power supply is never suit to the utilization of dielectric motors, because those motors can only be fed and function by high voltage pulse power supply.

Although power MOSFET semiconductors can be used to make the wanted super high voltage pulse and frequency varying power supply by converting the commercial hydro power, however the limitation of transistor reverse breakdown voltage is always the bottleneck as in the aforementioned analysis, so that the MV-level pulse power supply dooms prohibitively expensive, despite of KV-level cheap but weak.

So the prerequisite to promote the dielectric motor is to promote the economical dielectric piston-driven high voltage generator.

§19. Avoiding Inhomogeneous Local Extreme Electric Field Along Transmission Line

As the ambient air's breakdown limit is under 3 MV/m, even reduced to 300 KV/m in the worst uncontrolled climate, high voltage transmission from source to destination is always challenging.

The insulator and conductor's geometry performance should be well considered to prevent from leaking and accident.

Geometrically conductor should be in decent gauge, smooth, straight running or around corner in large radius. Theoretically when charges distributed on curve surface, inhomogeneous strong nearby field will appear, and the more curve, the higher field, that is why tip point prone to breakdown insulator.

For a sphere with radius R and uniform charge density ρ, the nonlinear analytic solution can be derived here from the simplified Poisson's and Laplace's equations:

$$\frac{{\partial }^{2} V}{\partial {r}^{2}} + \frac{2}{r} \frac{\partial V}{\partial r} = \frac{- ρ}{{ɛ}_{0}}$$

We get the local electric field E=∂V/∂r=−V/r.

Now, we can try some estimation: if the voltage 1 MV and there is a needle-shape protuberance with radius 0.1 mm, then the field around the tip will be 10 GV/m; or if 1 GV, then the field 10000 GV/m, and that will destroy any insulator or kill life, even result in unexpected nuclear reaction in unexpected place!

Therefore for safe transmission of extreme high voltage, the conductor and insulator are both very picky, even the diameter of conductor is very important, and should be as large as reasonable and possible. So, the regular thin stranded and twisted copper wire not recommended, and the plumbing copper pipe may be the preferred choice.

We can see easy sparks when a Tesla coil in fancy demonstration, that is inevitable because of thin copper wire windings causing conductor surface curvature induced breakdown effect; Luckily there is no such innate serious risk for dielectric high voltage generator itself because of almost all plain surface except minor edge mild curvature.

Although reduction of abrupt curving of conductor surface can benefit safe transmission, the resulted increase of conductor surface also dilutes the charge density on energy storing capacitor's plates, and then voltage may drop down, because of the capacitor's inside field proportional to plate's charge density, so just trim off unnecessary wiring.

As to insulation, regular insulator may be no longer good for extreme high voltage; instead the aforementioned AF45 special glass can be customized for this purpose. Extreme vacuum can also withstand extreme field.

Also the plates of the capacitor should be very smooth, and all corners of rectangular should be rounded, so are all electric joints surrounding area between different parts.

§20. Is Dielectric Displacement Generator Equal to Triboelectric Generator?

Although a triboelectric generator is very similar with dielectric displacement generator, the difference is still obvious: the former depends on dielectric material's capability of surface ionization caused by friction; the latter prefers charge-neutral bipolar media to reduce friction during displacement.

In a triboelectric generator, a material with high proneness of losing electrons during friction is matched with a material with high proneness of grabbing electrons, e.g. nylon-polyvinylchloride pair.

In a dielectric displacement generator, the significant deviation of dielectric constants between two media is most interested. The friction between electrode plates and dielectric combination is expected as low as possible.

### DESCRIPTION OF INVENTIONS AND EMBODIMENTS

The Root Invention #1—General Dielectric Piston Unlimited High Voltage Generator

In general, when dielectric medium in capacitor is switched from high permittivity ∈₁ to low one ∈₂, such a displacement needs input of mechanic energy, and in turn this mechanic energy will be converted to electrostatic energy, thus voltage will be multiplied greatly by ∈₁/∈₂>>1, though no charging current is infused to capacitor.

As no limit is imposed on ∈₁/∈₂ and many stages amplification is allowed, so there is no limit for the possible high voltage output, provided no breakdown occurs inside all dielectric media.

By employing new generation of dielectric materials with extreme high breakdown strength, plus providing as ample as needed space, GV level is not hard to reach, in contrast, with the prior art, even the record high voltage is merely under 50 MV.

With such a breakthrough invention, a virgin domain is looming large, enabling countless potentialities that may subvert traditional or stereotype design and engineering practice in many technical aspects, as well as many industries including the edged ones will be created or boosted, hence ultimately promote the globe economics.

Academically a new theory should be created to cover this blank background science of all here inventions, now, I name it “dielectrodynamics”, and will systematically write a textbook about it in near future.

As every new invention based on this root one is unprecedented, so that enumeration of prior arts seems unnecessary or futile, because of non-existence of related literatures.

The dielectric piston, aka “dielectric blades”, can be quite flexibly arranged in apparatus, so that 2 main streams of embodiments can be classified as reciprocal and rotary displacement, as illustrated in FIG. 1, and FIG. 2.

FIG. 1 shows an abstract dielectric media displaceable capacitor with mechanical input and voltage output. The electrode plates are like as “stators”, and 2 joined dielectric materials play lively as a laminating board “piston”.

The Greek letter ∈ also stands for material's dielectric constant, and as my protocol and as showed in all drawings, ∈₁ is always larger than ∈₂.

The sub-FIG. 1.a is the moment that dielectric medium ∈₁ fulfill inside capacitor, and the capacitor is charged by excitation voltage V₁ via dedicated switch that serves ∈₁ only; 1.b medium ∈₂ is the insider after exerting force, and the excitation voltage is amplified by ∈₁/∈₂ times; 1.c medium ∈₂ is liquid, ∈₁ solid, and whole capacitor is soaked under oil in a commeasurable container.

FIG. 2 shows the different variants of rotary displaceable capacitor mechanical-voltage transformer.

Similar to FIG. 1, instead of laminating board piston, the moving parts change to rotatable laminating disk, and instead of pull or push, rotating torque is exerted via shaft.

For 2-patal laminating disk, the electrode plates are semicircle disks, sub-FIG. 2.a shows the moment that medium ∈₁ is lodging inside capacitor and charged by voltage exciter that serves ∈₁ only; 2.b medium ∈₂ is switched into capacitor after 180° rotation, and capacitor output voltage is enlarged to V₁*(∈₁/∈₂).

In sub-FIG. 2.c, medium ∈₂ is liquid, ∈₁ solid, and whole capacitor is soaked under oil in a commeasurable container. In this case, the rotor is a semicircle disk with shaft.

Further, sub-FIG. 2.d visualizes multiple petals interlace laminating dielectric disk rotor, e.g. 4 and 8 petals. As ad hoc, the 2 check-pattern rotors comprise one medium in 2 and 4 petals, and only for use in vacuum or submersion of fluid, e.g. air, oil, etc.

In fact, one shaft can host many such dielectric disk modules if needed, for example, both 10 KV and 100 KV double modules.

As during the voltage increase, powering load will dampen the max accessible voltage, so such a device is most likely used in pulse mode.

To vary the sharpness of pulse, the dielectric blade's geometry size is expected in proper configuration, as illustrated in FIG. 3: reasonable input or output window determined by media over-cover plates.

For the reciprocal model, W₁>W enables excitation voltage enough time to recharge capacitor, W₂>W enables output voltage enough time to power load. Such a case is showed in sub-FIG. 3.a, where W stands for width of electrode plates, and W₁ width of medium ∈₁, W₂ width of medium ∈₂.

For the rotary model, θ₁>θ enables excitation voltage enough time to recharge capacitor, θ₂>θ enables output voltage enough time to power load. Such a case is showed in sub-FIG. 3.b, where θ stands for arc angle of electrode plates, and θ₁ arc angle of medium ∈₁, W₂ arc angle of medium ∈₂.

If δW=Wᵢ−W, or δθ=θᵢ−θ (i=1 or 2) too small, even close to zero, the rest stay width, or pulse width of recharge or discharge could be very or extreme narrow, by specially arranging the load, it is possible to simulate the explosive effect, such as Z-pinch setting, water explosion, etc.

Generally speaking, the specific power will be enlarged at least to W/δW or θ/δθ times, and it is guaranteed by the mechanism. For example: if W/δW=1000, and engine input mechanic power 1 KW, then minimal output pulse power is 1 MW.

As the load can be arbitrary, the real pulse width can be far short than the mechanism guaranteed max width, so the above exampled conservative 1 MW could be 1 GW or more in some applications, such as Z-pinch.

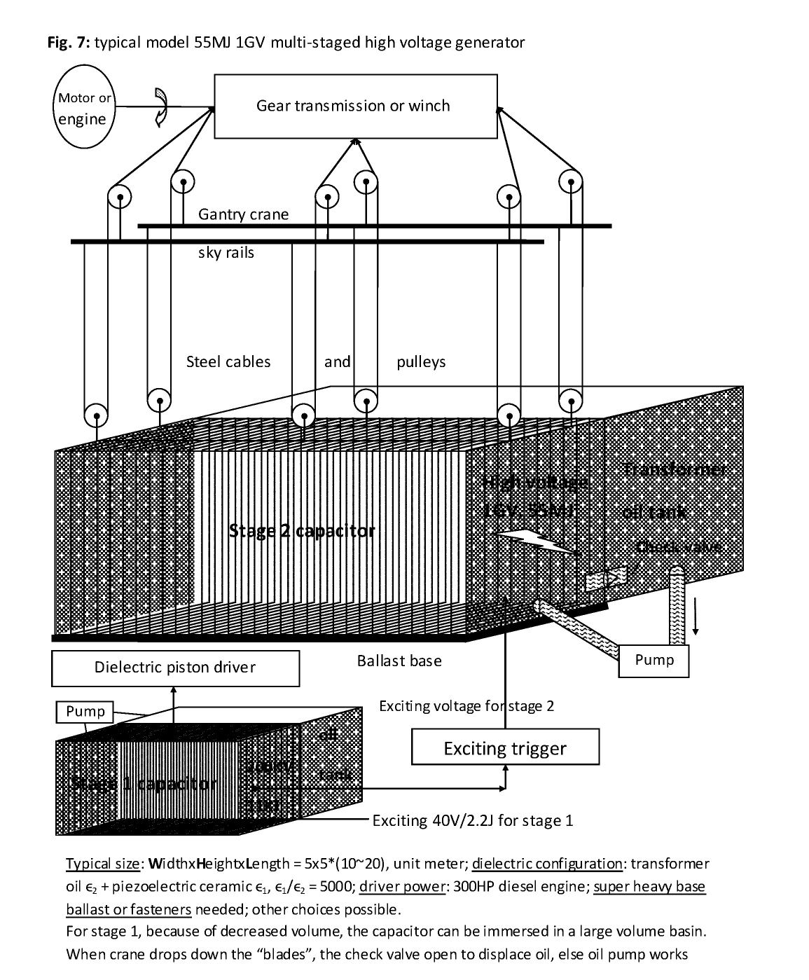

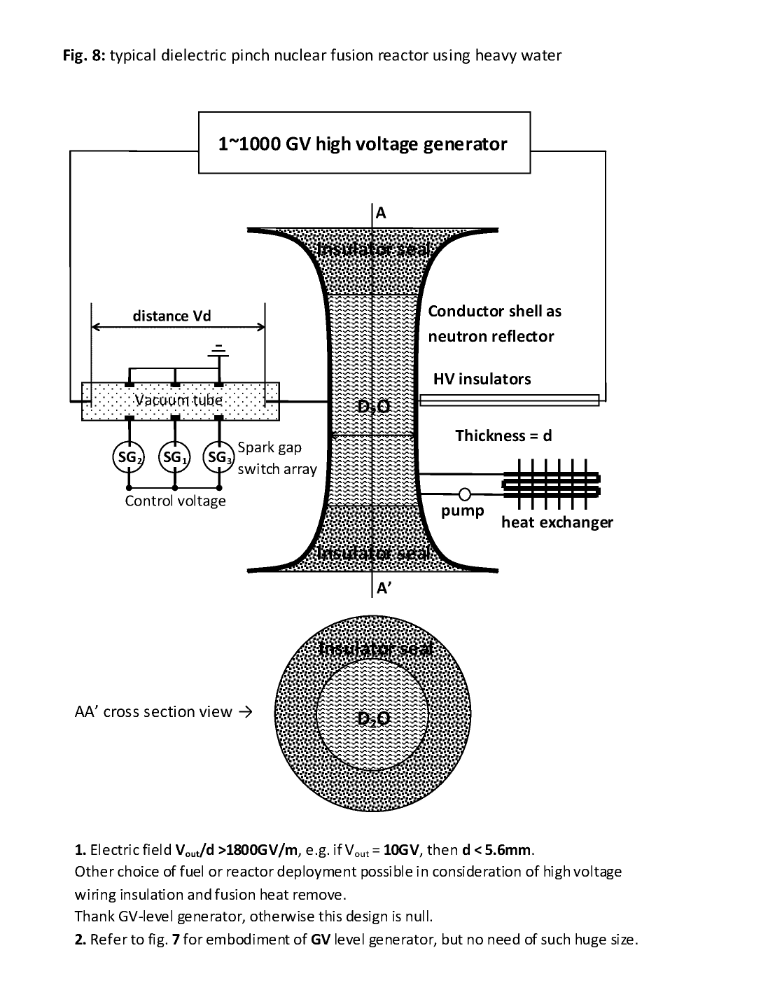

FIG. 7 shows a typical 55 MJ 1 GV multistage single shot high voltage generator.

A powerful engine, e.g. 300 HP diesel engine, provides the system all energy. It drives a heavy duty gear transmission or winch.

There are some sturdy sky rails used as gantry crane. Many pulleys are mounted on the rails and on the huge dielectric blades assembly. Steel ropes are crossing pulleys in force saving mode, then hooked to the said transmission or winch.

The dielectric blades can be made of dielectric media combination of ceramic piezoelectric material with high dielectric constant ∈₁ and transformer oil ∈₂ with high breakdown strength, e.g. δ₁=22600, ∈₂=4.5, δ₁/∈₂=5000.

For a detail calculation of parameters, please check the sub-section 10 “Design exercise” in section “science behind inventions”.

Because transformer oil is fluid, displacement can be done by gravitation or atmosphere pressure or pump depending on how fast demand, and an oil tank is deployed beside the dielectric blades module. When the said ∈₁ is completely inside the capacitor, the oil is displaced to the tank via the check valve, as well as when the dielectric blades module is lift by the crane, the oil will flow back and be pumped to the capacitor.

Without check valve and pump, the stage 1 excitation module can be completely immersed in oil basin, as the volume is far less than the stage 2 module.

As hundreds tones force involved in stage 2 module, the base should be well blasted.

The typical size for such a performance could be 5 meters wide and height, and 10 to 20 meters long depending on how density the intermediate electrode plates inserted.

### Extended Invention #2—Dielectric Pinch Nuclear Fusion Reactor

Provided voltage can be as high as demanded, nuclear fusion no longer hard to realize.

As analyzed in the section of science behind the inventions, if the electric field strength can attain 1800 GV/m, then the pinch force can easily fuse light nuclei.

It is the field strength, not the voltage itself that is so important to the successful fusion, however, the higher the voltage, the more methods and higher feasibility to reach higher field strength, because lower voltage demands shorter distance for same field strength, however in turn, too tiny or too thin will frustrate engineering embodiment.

For example, to reach 1800 GV/m, if only max 5 MV available, that demands a distance of electrode plates 2.8 μm, hence for nuclear reaction, such a tiny geometry size makes engineering obviously extreme difficult; but if 10 GV available, the distance becomes 5.6 mm, then engineering frustration will be solved.

With unlimited voltage increase, the space occupation is no longer negligible, because the higher the voltage output, the greedier housing dimension, e.g. for 10 GV output, the distance of the capacitor's main electrode plates may be as large as 100 meters to 200 meters above, depending on the work media dielectric breakdown parameters, further brain storming, if 1000 GV, then 10 km span for regular dielectric material or 1 km for the new generation material AF45, may be needed.

Another challenge is how to manipulate such a huge high voltage. In fact, none regular switch could harness 5 MV above voltage. Not to mention of switching, the well known Tesla MV level voltage generator always leaks random fancy arcing streamers around.

So a sophisticated switch for extreme high voltage should be considered first.

Vacuum tube is always good choice for switch purpose, and the greater distance of switch electrodes (not the control electrodes), the greater voltage (not control voltage) it can withstand.

Because the GV level voltage is extreme high, it demands very long vacuumed distance to separate live terminal and load terminal, obviously regular spark can not be used here because of its limited switch distance, but a properly customized long vacuum tube does work, and anyhow the spark gap switch can be used in the control circuit.

By creating some live ions inside a vacuum tube, the switch can be turned on quickly by avalanche effect. This can be done by many methods, e.g. laser irradiation, radioactive approach, or middle local ionization activated by breakdown in orthogonal direction.

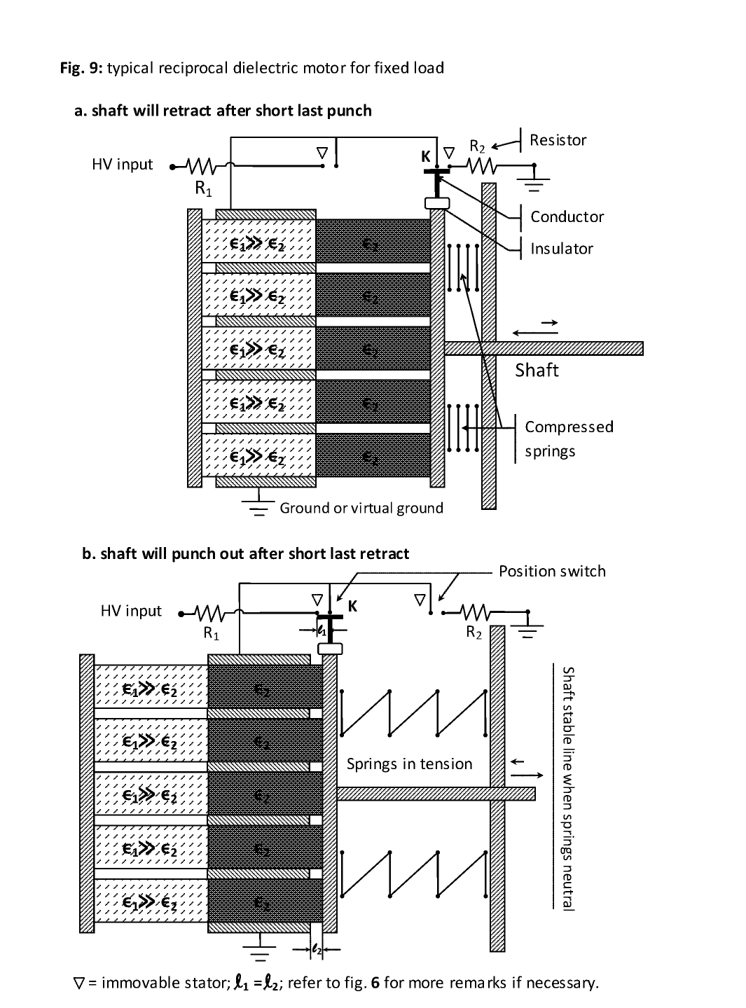

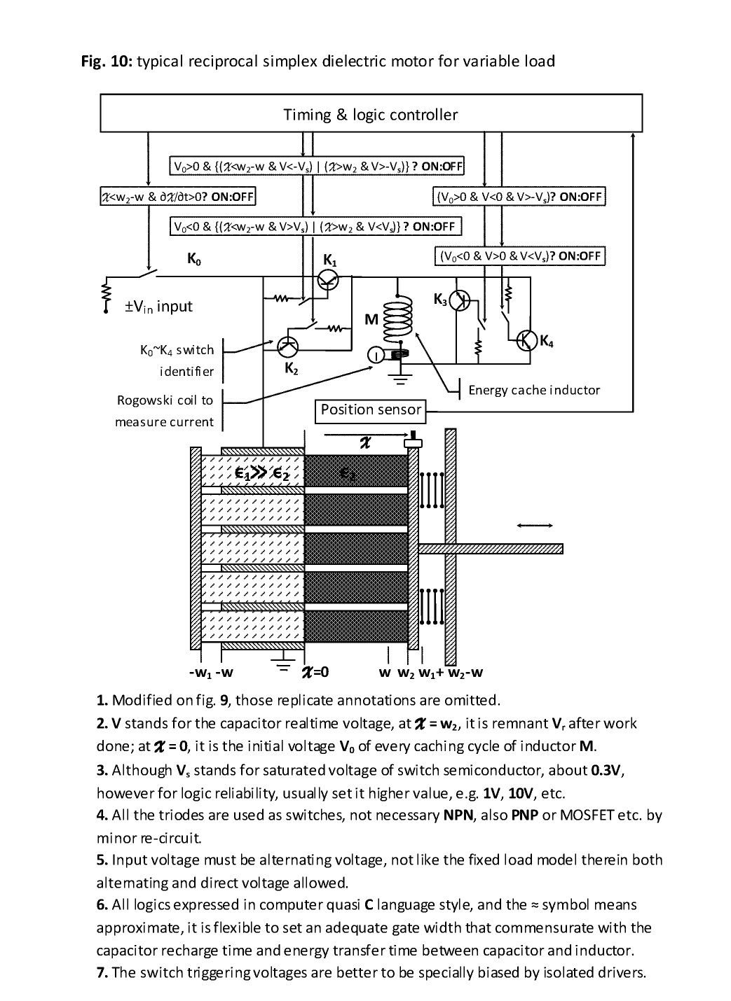

FIG. 8 shows a dielectric pinch nuclear fusion reactor which fuel is just heavy water.

The middle electric breakdown induces lead streamer first before full turn-on, and the lead streamer favors decent ion density, thus a single orthogonal ionization breakdown field may be not enough, so it may need multiple breakdown fields distributed along the switch way to facilitate reliable triggering, e.g. 3 spark gap switch controlled triggering array in the subject figure.

The breakdown field control voltage is far less than the switch voltage, so it can be created from whatever convenient traditional methods.

Depending on the applied GV-level high voltage source, the customized vacuum tube may be as lengthy as hundreds meters.

Although such a monster switch vacuum tube seems inconvenient, however the desire of switchless configuration is hardly feasible, because if no switch is inline and the load is connected directly to the GV-level generator, then the relative slow rising session of voltage will prematurely breakdown the nuclear fuel, then in turn, the expected high voltage will fail because any electric current drawing load is ill during voltage soaring.

After the expected high voltage is gained and then the vacuum tube switch is turned on, the initial electric field of the fuel is about the expected extreme high ignition value, so as to trigger nuclear reaction because of the crackdown of atom coulomb barrier, not to mention the simultaneous dielectric breakdown.

Although intuitively the dielectric breakdown seems to occur earlier than crackdown of atom coulomb barrier, it does not accurately reflect the reality, because the usual hesitation time of dielectric breakdown caused by electron avalanche is far longer than the instant crackdown of atom shell that reacts in light speed.

Wiring insulation is another challenge for such an extreme voltage, however it is always solvable by careful design and engineering plan.

Other choice of fuel or reactor deployment is possible in consideration of high voltage wiring insulation and fusion heat remove.

Not only pinch can facilitate fusion reaction, it also accelerate isotopic beta decay, especially β⁺, thus, instead of heavy water as fuel, some special isotopes can also be good pinch fuel, such as potassium K-40 with low natural abundance 0.0117%, or tellurium Te-123 with abundance 0.89%.

By utilizing β⁺ radioactive elements as fuel, raw conductive metal should be avoid, because only dielectric material is preferred in pinch acceleration reaction, hence, the wanted elements should be composited in dielectric compound.

Possible nuclear reactions:
O¹⁶+D→F¹⁸+7.53 MeV→O¹⁸+1.66 MeV
D+D→n+He³+3.23 MeV
D+D→p+H³+4.03 MeV
C¹²+n→C¹³+4.95 MeV (moderator electrode)

Heavy water itself is not a good neutron absorber. Neutron moderation and absorption can be done by thick graphite or other high neutron absorption electrodes.

The nuclear energy is converted to heat of water, and by circulating the hot water via heat exchanger, the output can be further converted to electric energy at last.

The fuel and container entirely is similar to a sunken disc with both ends insulator sealed, and the conductor shells play multiple functions: electrode, neutron reflector and absorber.

By controlling the repeat rate of GV-level generator, the fusion power output can be easily regulated.

Refer to FIG. 7 for embodiment of GV level generator, but no need of such huge size 55 MJ model for fusion application, perhaps the slim embodiment with a few of kilojoules capacity is good enough. A sub-section in “science behind inventions” also presents parameter calculation for different energy capacity models.

Thank GV-level generator, otherwise this fusion reactor is null.

Extended Invention #3—Dielectric Utility Electric Motor

§1. Fixed Load Dielectric Motor

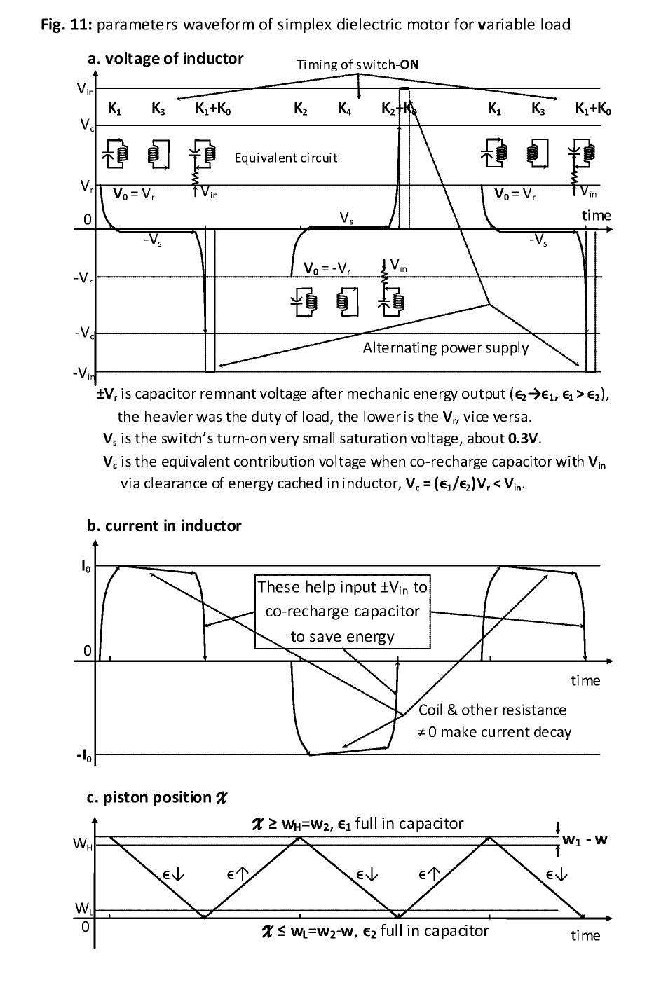

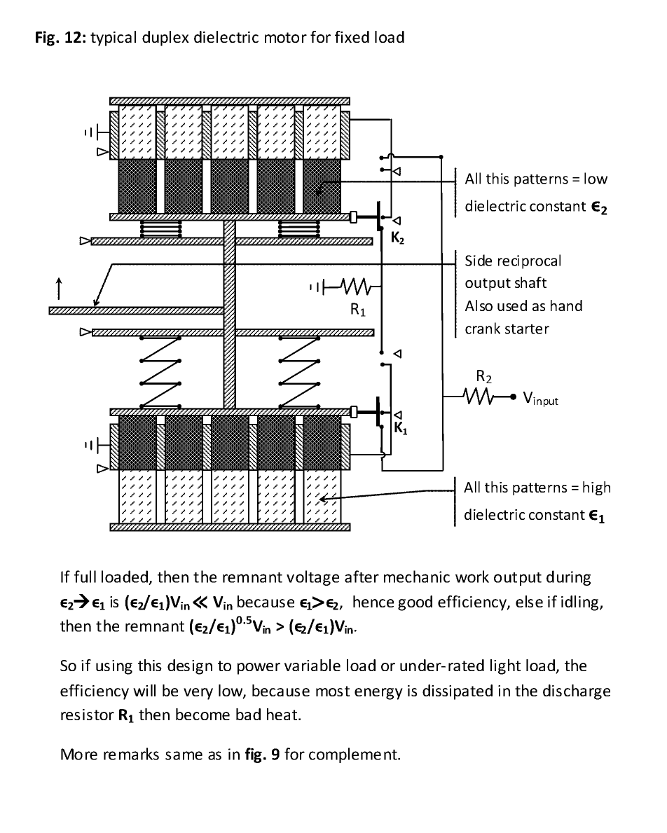

The simplest dielectric displacement motor can be construed as a reciprocal simplex model showed in FIG. 9: typical reciprocal dielectric motor for fixed load. Later analysis will show that it is only good for a reasonable given load drive.

It comprises basic dielectric media pair, main electrode plates, inserted electrode plates that can be wired to main plates via cascade or parallel mode, springs, shaft, resistors that limit discharge current or recharge current, and switches.

The 5 pieces of dielectric blades combination is only for graphing convenience, in fact, the real count can be as many as needed in dependence of embodied design. This statement applies to all figures.

FIG. 9a shows the snapshot position that shaft is almost ready to retract after short last punch. The last short distance to the dead end is [symbol] ₁ that equals to [symbol] ₂, i.e. the length difference value of dielectric blades and electrode plates.

The compressed springs will recoil against dielectric combination piston, and low drag force cooperates with spring force because the initial voltage is zero and no chance to increase even when the higher dielectric constant medium is displaced by the lower one.

With the position switch K beginning to turn on, the initial voltage is reset to zero by a simple discharge circuit via a resistor R₂, and the discharge duration is about the hesitation time near the dead end with a small itinerary trip 2* [symbol] ₁ which is the width of position switch's reed.

FIG. 9b shows the position that shaft is ready to punch out.

At the moment of piston approaching dead point, the position switch connects power supply with input terminal of capacitor module, and then electrostatic energy is stored.

As springs are in tension because of over-stretched apart from equilibrium, as well as dielectric piston tends to be accelerated because the lower dielectric constant medium is going to be displaced by the higher one.

After the dielectric piston or blades punched out, then next cycle will start gain, and so on recirculation to function as a reciprocal electric motor.

The grounding sign in the figure is at least the “virtual grounding” that only means all the same marked terminals are linked together electrically for graphing convenience, in some cases, real grounding to earth maybe necessary if otherwise specified, but not always necessary or allowed.

A slight alternative design is presented in FIG. 12 with feature of duplex model that can more powerfully work than the simplex one.

In this model, when piston at dead point, the dielectric media inside two capacitor modules are different, so that springs force is no longer important because in both movement direction can the piston be accelerated.

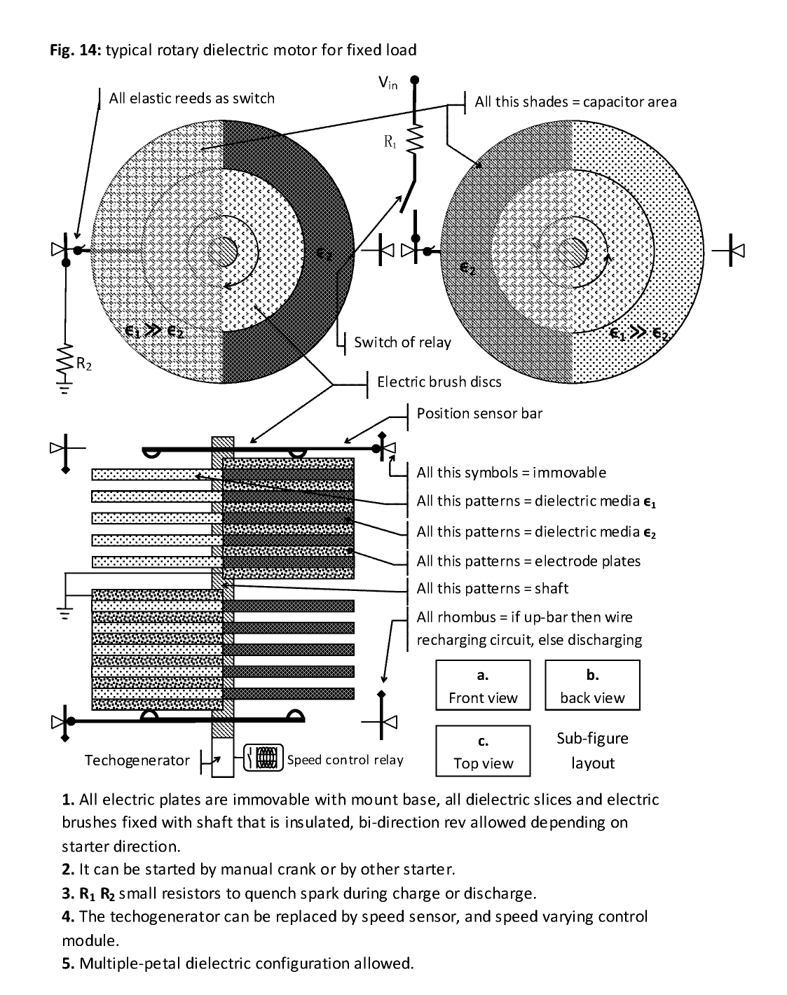

As rotary motors seem to be more welcomed, and FIG. 14 is just such an embodiment.

It is almost same thing with the FIG. 12 duplex model except the output is torque power.

All electrode plates are immovable with mount base, as well as all dielectric slices plus two electric brushes are fixed on shaft that is electrically insulated, so that dielectric slices rotate with the shaft.

There are two variable almost semi-cylindrical capacitor modules in tandem along shaft with opposite dielectric phase that means the dielectric contents in the 2 capacitors complementary at anytime.

For each capacitor module, there is a pair of position sensors that are just simple position switches and an actuating rod fixed on the electric brush disc: one switch will be triggered to discharge leftover voltage to ground, if the higher dielectric constant media is fully inside capacitor; the other one will be triggered to recharge capacity with input high voltage, if the lower dielectric constant media is fully inside capacitor.

There is a semi-ring of elastic metal on the electric brush disc, and the ring brush can always keep connecting with the correct one of capacitor's electrode plates.

Per every 180° the shaft rotates, one of the pair switches will be triggered in turn.

Either recharge or discharge may need an inline reasonable resistor for limiting current and quenching spark.

All electric plates are immovable with mount base, all dielectric slices plus electric brushes fixed on shaft that is insulated, and bi-direction rotation is allowed as per starter direction.

A techogenerator is coupled with shaft, so its output can power a relay that will turn off the power supply when rev rate reaches the preset top limit. It can also be replaced by speed sensor, and speed varying control module.

Multiple-petal dielectric configuration is allowed for disc style dielectric motor.

Like as most regular AC motor, this new type of motor also need be started before stable running, usually by manual crank or by other starter.

If full loaded, then the remnant voltage after mechanic work output during ∈₂ to ∈₁ is Vᵣ=(∈₂/∈₁)Vᵢₙ<Vᵢₙ because ∈₁>∈₂, hence good efficiency, else if idling, then the remnant (∈₂/∈₁)^{0.5}Vᵢₙ>(∈₂/∈₁)Vᵢₙ.

For example, if ∈₁/∈₂=10, then during ∈₂ to ∈₁, the remnant energy of full load case is about 10% of input, so dumping the remnants to a resistor is acceptable, as even so, the efficiency of electric to mechanic energy is still 90%, seems decent as regular AC motor; else if ∈₁/∈₂=100, then 99% almost perfect!

§2. Variable Load Adaptive Dielectric Motor

Simplex Dielectric Motor for Variable Load Adaptation

However, if using aforementioned design to power variable load or under-rated light load, then the efficiency will be very low, because most energy is dissipated in the discharge resistor R₁ then becomes deplorable heat.

For regular AC motor, the variable load is tolerable, because of no significant wasted energy, as this result is buffered by phase shift between voltage and current, so even in the worst case, only power factor is affected, and it can be compensated by paralleling adequate capacitor, or simply using thick wire to counteract the current increase.

But for the dielectric motor working in variable load, no means of adjusting power factor, so a complicated design should be used; even a μCPU-based controller may be needed.

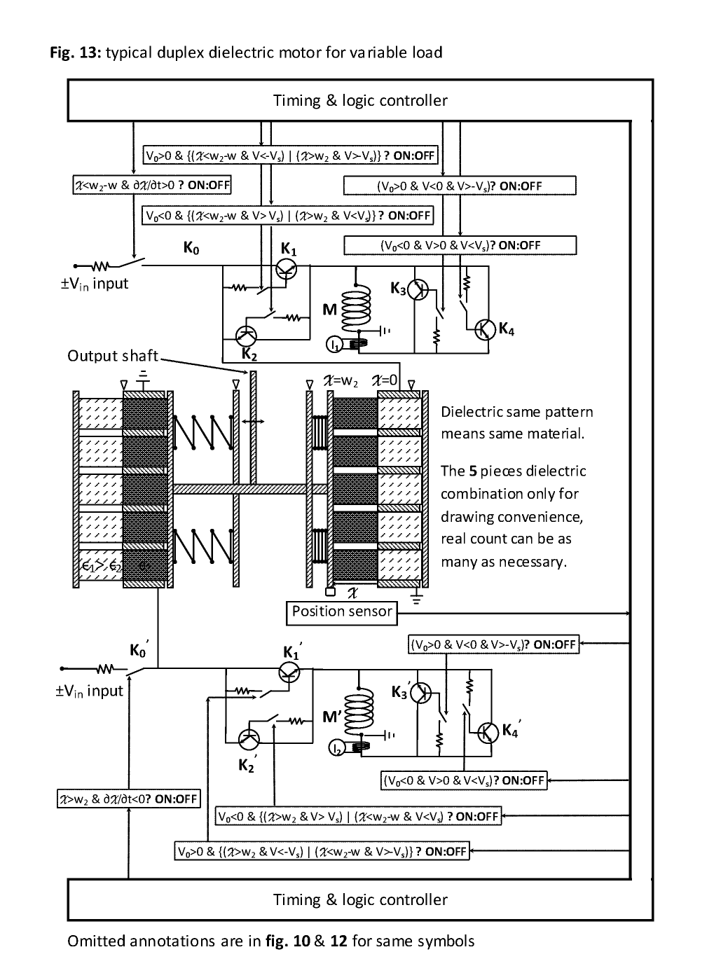

Modified on FIG. 9, FIG. 10 is a typical reciprocal simplex dielectric motor for variable load, for tidy, those replicate annotations are omitted, only new parts annotated.

The motor frame maintains same with the fixed load model, except simple position switches are replaced by solid state switches controlled by timing and logic controller.

To reuse the remnant energy after ∈₂ to ∈₁ of mechanic work output period, a coil, aka inductor, should be used to temporarily cache the said remnant energy, so that capacitor is discharged to zero or near zero voltage to prevent voltage increase and unnecessary internal consumption of mechanic energy during ∈₁ to ∈₂.

After ∈₁ to ∈₂, supposedly the capacitor should be fully charged to the power supply voltage Vᵢₙ. Of course, the cached energy in the inductor should not be forgotten, so retransfer back it to capacitor can save infused recharge energy of power supply, hence increase efficiency.

As the changing direction nature of voltage or current during the transfer and retransfer between capacitor and inductor, the input voltage must be matched alternating voltage, not like the fixed load model therein both alternating and direct voltage allowed.

Generally speaking, the solid switches cannot perform perfect ideal turn-on with zero voltage between 2 terminal leads; there always must be very small voltage that is referred as saturation voltage Vₛ, about 0.3V for regular one.

Unless the turn-on voltage is far higher than Vₛ, saturation voltage will not cause high percentage loss.

Although all triodes in the figure are drawn as NPN transistors, however it is not a must, also possible of PNP or MOSFET etc. which can be used only by minor re-circuit.

As to the toggling of solid state switches, lots of possible wirings do exist. For easy abstract, hereinafter, logic expressions are used as triggering criteria.

All logics are expressed in computer quasi C language style, and the “≈” symbol means approximation, it is flexible to set an adequate gate width that commensurate with the capacitor recharge time and energy transfer time between capacitor and inductor.

Although Vₛ really small, however for logic reliability, usually set it higher value, e.g. 1V, by, etc. when calculating logic expressions.

In the figure, alternating ±Vᵣ is capacitor remnant voltage after mechanic energy output (∈₂ to ∈₁ and ∈₁>∈₂), as a general rule, the heavier was the duty of load, the lower is the Vᵣ, vice versa.

The mnemonic symbol χ is the reading of piston position sensor, w₁ is the size of ∈₁, w₂ is the size of ∈₂, w is the size of electrode plates; V stands for the capacitor real time voltage, and at first time of χ=w₂, it is just the remnant Vᵣ after work done, at first time of χ=w₂−w, it is the saved initial voltage V₀ at the beginning of every energy caching cycle of inductor.

There are mainly 5 logic expressions for the respective switches:

For energy transfer or retransfer between capacitor and inductor, the toggling logics are:

Switch K₁->(V₀>0) & {(χ<w₂−w & V<−Vₛ)|(χ>w₂ & V>−Vₛ)}? ON:OFF
Switch K₂->(V₀<0) & {(χ<w₂−w & V>Vₛ)|(χ>w₂ & V<Vₛ)}? ON:OFF

For the inductor magnetic energy keeping switches K₃ and K₄, their triggering logics are:

(V₀>0 & V<0 & V>−Vₛ)? ON:OFF, following +Vᵢₙ input during ∈₁ to ∈₂;
(V₀<0 & V>0 & V<Vₛ)? ON:OFF, following −Vᵢₙ input during ∈₁ to ∈₂.

For the main input switch K₀, this logic governs it: χ<w₂−w & ∂χ/∂t>0? ON:OFF, or χ<w₂−w & I==0? ON:OFF, where I is the realtime current measured by a Rogowski coil in the energy caching inductor.

As the gate voltage of PN junction of triode's base-emitter is 0.7V, higher than the turn-on saturation voltage of collector-emitter 0.3V, so that wiring the triode's collector electrode to the gate bias voltage supply is not a perfect method, and it is better to use other means, such as isolated drivers to bias the gate base electrodes.

Reading FIG. 11 can greatly help understand the technical principle behind this invention. This figure vividly displays the essential parameters timing waveform of simplex dielectric motor for variable load.

FIG. 11a shows waveform of inductor voltage and switches turn-on timing information.

The mnemonic symbol V_{c} is the equivalent contribution voltage when co-recharge the capacitor with Vᵢₙ via clearance of energy cached in inductor, V_{c}=(∈₁/∈₂)Vᵣ<Vᵢₙ.

That means if the inductor co-recharge fills up 40% to capacitor then the power supply only needs to supplement 60% to reach full value of Vᵢₙ It obviously shows how it saves energy and enhances efficiency.

The triplet icons illustrate the equivalent circuit of energy caching: quick transfer, hold during almost a full piston stroke, and quick retransfer.

In ideal condition, the inductor is made of expensive superconductor material, then zero energy loss. But a full piston stroke only spends very small time slice, so that even cheap material of conductor can do a good job of magnetic energy cache. FIG. 11b shows a slow current decay curve during holding time, because coil and other resistance ≠0.

The mnemonic symbol I₀ stands for the max current in inductor. It can be calculated via energy conservative equation:

0.5*Capacitance*V₀²=0.5*Inductance*I₀²

FIG. 11c shows the dielectric piston displacement χ dynamic curve. When χ<w₂−w at about one end, the dielectric medium ∈₂ is fully in capacitor, as well at χ>w₂ at about another ends, ∈₁ is fully in capacitor.

As during hesitation at both ends, the reciprocating direction will be change, so ∂χ/∂t, i.e. the partial differential to time, can be used to indicate the direction, or say, trend of increase or decrease.

Duplex Dielectric Motor for Variable Load Adaptation

After clear description of simplex dielectric motor for variable load adaptation, it is getting easy to understand the duplex one.

Principally the duplex just doubles the simplex model in module configuration with half-cycle phase shift.

It can save some duplicate sensors and CPU-based parts, such as only needs one position sensor, and one timing plus logic controller.

FIG. 13 shows a typical duplex dielectric motor for variable load.

As two actuating mechanisms share one position sensor and controller, the logic expressions for the counterpart mechanism needs minor phase adjustment.

The χ in this figure is the displacement measurement of the right mechanism module in the figure, assuming there is a virtual sensor to measure χ′ the left one, then χ′=2w₂−w−χ. Thus if χ=w₂ then χ′=w₂−w; else if χ=w₂−w then χ′=w₂.

So, all the control logic expressions can be slightly modified as follows for the switches in the counterpart mechanism module.

Switch K₀′->χ>w₂ & ∂χ/∂t<0? ON:OFF, or χ>w₂ & I₂==0 ? ON:OFF
Switch K₁′->(V₀>0) & {(χ>w₂ & V<−Vₛ)|(χ<w₂−w & V>−Vₛ)}? ON:OFF
Switch K₂′->(V₀<0) & {(χ>w₂ & V>Vₛ)|(χ<w₂−w & V<Vₛ)}? ON:OFF
Switch K₃′->(V₀>0 & V<0 & V>−Vₛ)? ON:OFF
Switch K₄′->(V₀<0 & V>0 & V<Vₛ)? ON:OFF

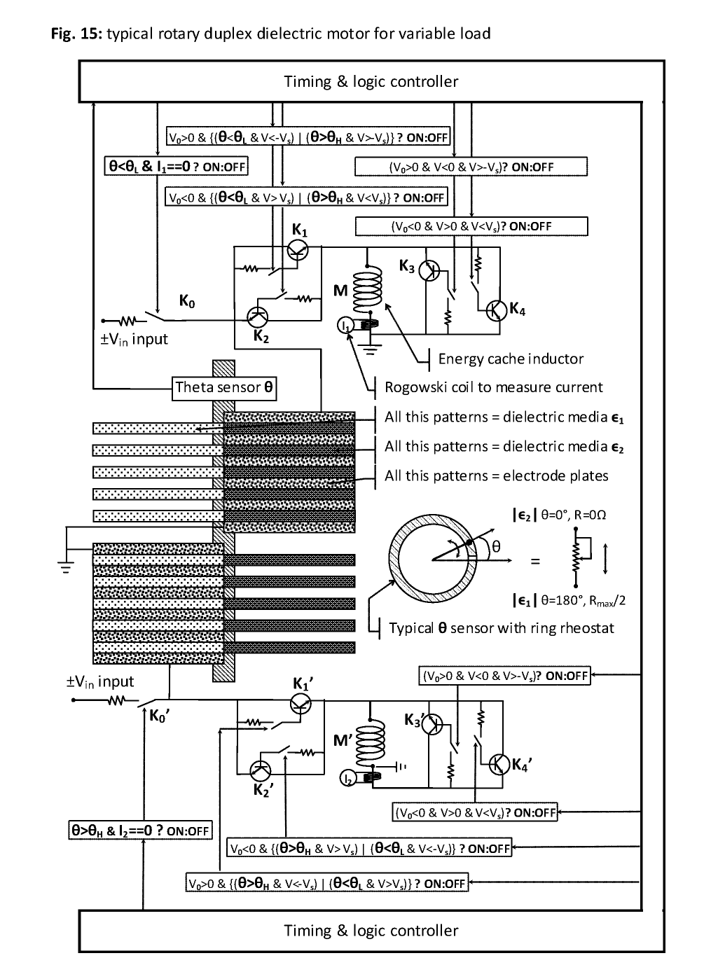

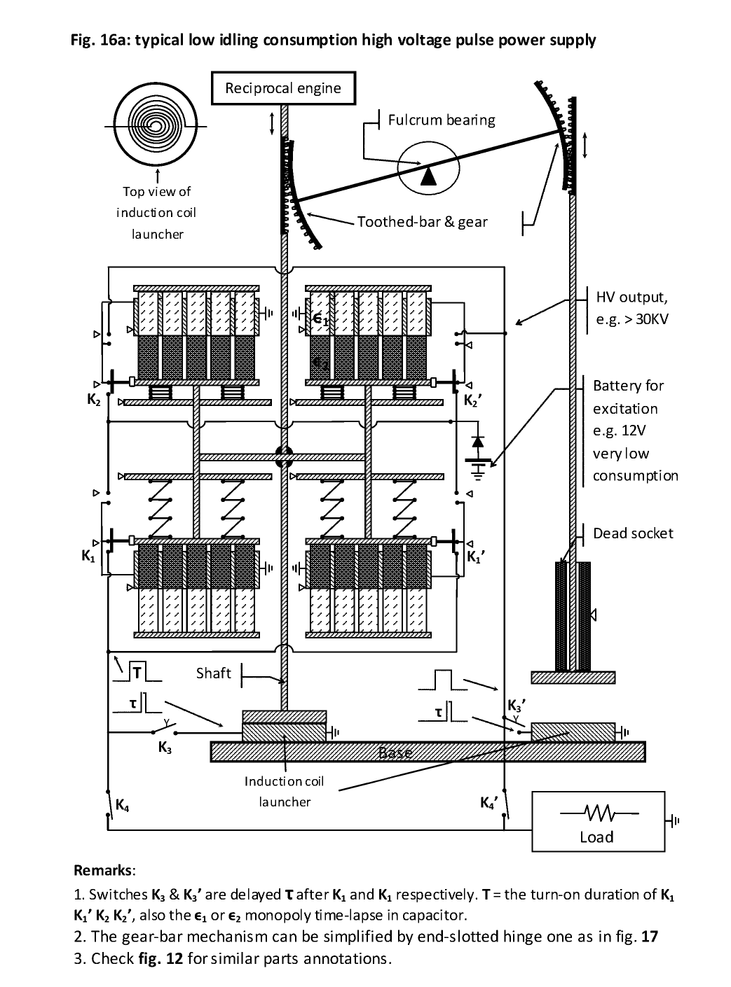

FIG. 15 shows a typical rotary duplex dielectric motor for variable load.

This model is exactly the same with the previous reciprocal one except the key control parameter is changed from translational displacement χ to angular θ.

The theta sensor can be simply a ring rheostat just like the equivalent variable resistor showed inside the figure.

At θ<θ_{L}, dielectric medium ∈₂ is fully in capacitor, and at θ>θ_{H}, ∈₁ is fully in capacitor. In the figure, |∈₁| or |∈₂| means the specified dielectric medium fully inside capacitor.

Similarly we can rewrite all logic expressions for all switches:

Switch K₀->θ<θ_{L} & I₁==0 ? ON:OFF
Switch K₁->(V₀>0) & {(θ<θ_{L} & V<−Vₛ)|(θ>θ_{H} & V>−Vₛ)}? ON:OFF
Switch K₂->(V₀<0) & {(θ<θ_{L} & V>Vₛ)|(θ>θ_{H} & V<Vₛ)}? ON:OFF
Switch K₃->(V₀>0 & V<0 & V>−Vₛ)? ON:OFF
Switch K₄->(V₀<0 & V>0 & V<Vₛ)? ON:OFF
Switch K₀′->θ>θ_{H} & I₂==0? ON:OFF
Switch K₁′->(V₀>0) & {(θ>θ_{H} & V<−Vₛ)|(θ<θ_{L} & V>Vₛ)}? ON:OFF
Switch K₂′->(V₀<0) & {(θ>θ_{H} & V>Vₛ)|(θ<θ_{L} & V<−Vₛ)}? ON:OFF
Switch K₃′->(V₀>0 & V<0 & V>−Vₛ)? ON:OFF
Switch K₄′->(V₀<0 & V>0 & V<Vₛ)? ON:OFF

Although many logic controls used in variable load adaptive dielectric motor, it does not mean hard or expensive to realize, in fact, there are many ways to implement all aforementioned logic expressions, not only a smart embedded system can do, but also can specially designed circuit do, either economic or a little bit extra cost.

Deep Logic Abstract

As no matter what style of the adaptive dielectric motor, simplex, duplex, translational or rotary, the control logic set is same or highly similar.

To reflect that fact concisely and abstractly, hereby I define a new concept—KLP, i.e Key Logic Package: a set of logics that at least contains following logic expressions to control following 5 basic switches.

### Switch K₀:

ThePos≈Endpont1 & Inductor_Energy_empty? ON:OFF

### Switch K₁:

(V₀>0) & {(ThePos≈Endpont1 & V<−Vₛ)|(ThePos≈Endpont2 & V>−Vₛ)}? ON:OFF

### Switch K₂:

(V₀<0) & {(ThePos≈Endpont1 & V>Vₛ)|(ThePos≈Endpont2 & V<Vₛ)}? ON:OFF

### Switch K₃:

(V₀>0 & V<0 & V>-Vₛ)? ON:OFF

### Switch K₄:

(V₀<0 & V>0 & V<Vₛ)? ON:OFF

The symbol ≈ means approximate equal, so above quasi C language expressions need to be detailed regarding the said symbols according to the accuracy requirement and all component's geometric dimensions.

Besides those already stated mnemonic parameters, only 2 new mnemonics should be generalized: ThePos stands for the position sensor reading, it can be translational coordinate or rotary angle or others; EndPoint1 stands for one terminal position value of ThePos, and EndPoint2 for the other one.

The pronoun KLP will be used in the section of right claims.

Before a full stop sign to the description of dielectric motor, it is necessary to clarify that the 5 pieces dielectric combination in all listed figures only for drawing convenience, not the real count, in fact, the real count can be as many as a reasonable capacitor required.

Also many annotations may be omitted in latter figures if in former figures the similar symbols or parts already annotated therein.

Extended Invention #4—Dielectric Piston HV Periodic Pulse Machine for Variable Load

When a pulse power supply is customized for a constant load, it is relatively easy because input and output are usually well matched.

But for universal periodic shots pulse power supply, things are getting complicated, because the loads are changeable time by time or shot by shot, and the ready manufactured machine may not be flexible enough to cope with all different loads.

Unmatched application is usually very low efficient and even risks of damage or huge energy waste, just analogous to bombard a mosquito by flak cannon.

Hereby I present an adaptive pulse power supply driven by a reciprocal engine or motor, and in fact, a rotary engine is indirectly workable too, just by simple rotary to reciprocal conversion mechanism.

If driven by motor, the motor can be a regular electric motor or linear electric motor or hydraulic motor or other whatever type.

As manifested in the section of “science behind inventions”, for a sustainable operation, the generated voltage output of dielectric blades displacement transformer should be consumed in time, otherwise it will block next cycle or result in electric breakdown, so that suspension of load, i.e. idling, is not allowed.

If the load only consumes a small percentage of total pulse energy, then the leftover energy should be dumped somewhere, or fed back to input.

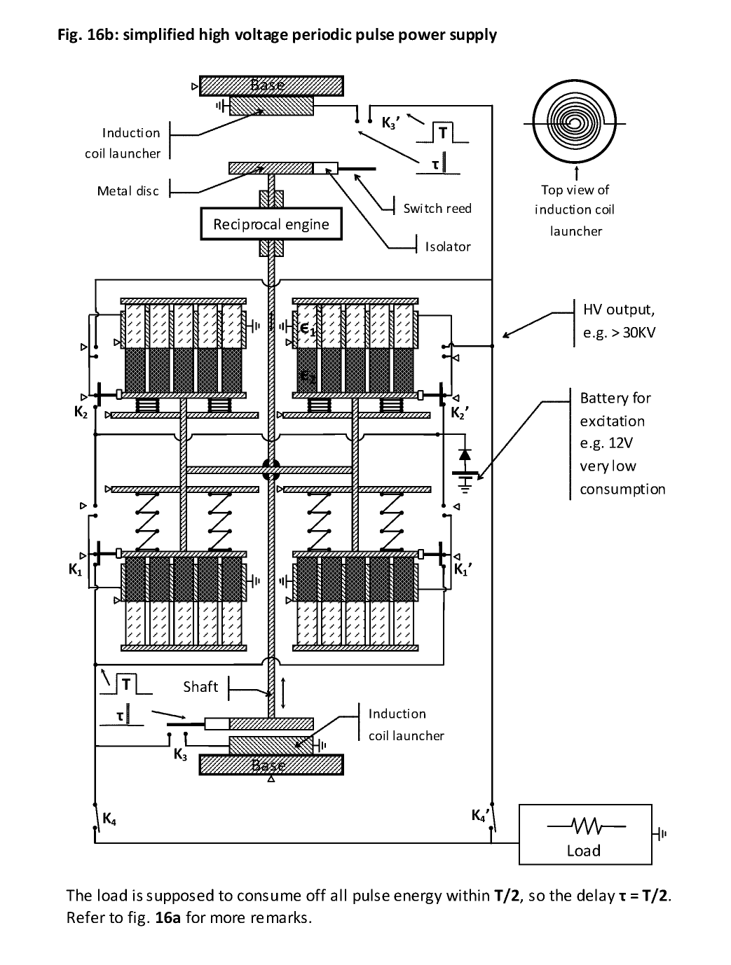

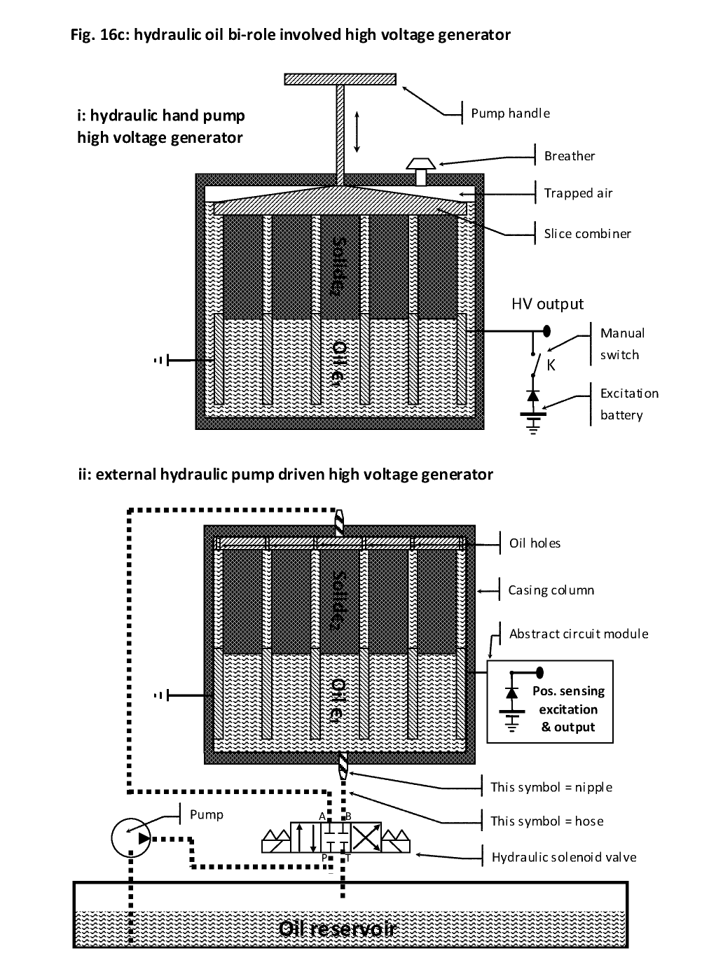

Feedback of unused energy to input is good idea to conserve energy. The design in FIG. 16a just follows this good practice.

This figure presents a typical low idling consumption high voltage pulse power supply, and its rationale is further explained in following paragraphs.

Because the electrode size is always shorter somewhat than the dielectric blades, so that either medium ∈₁ or ∈₂ can monopolize the capacitor for a small hesitation time T during a short reciprocal trip.

Setting a delay time τ<T, as long as one dielectric medium is fully displaced out from capacitor, i.e. either K₁ K₁′ or K₂ K₂′ just turn-on, the timing is beginning, then after τ lapsed, automatically turn on the respective switch K₃ or K₃′ to energize the respective induction launcher with remnant energy to assist the engine.

The delay switches can be controlled by embedded microcomputer or dedicated circuit.

While one pair capacitor ready to output pulse, simultaneously the other pair capacitor will begin to be recharged by an excitation battery.

The hinge mechanism is not limited to the illustrated toothed bar and arc or wheel gear, simple end-slotted lever hinge system also workable.

The status of load switches K₄ K₄′ can be arbitrary so as to feature the load adaptive performance. When turn off, the machine is totally idling, otherwise either light load, partially idling, or full heavy load.

For economic reason, previous system can be further simplified as illustrated in FIG. 16b.

The costy hinge transmission in FIG. 16a is omitted, but the drive shaft should run through the engine block, so as to feedback remnant energy from opposite ends.

And the delicate delay controller is also omitted; instead simple position sensing switches are attached to the induction coil launchers. However, the delay time can only be T/2, and the pulse energy is supposed to be consumed within T/2 after any duet of dielectric blades triggered respective position switch.

For constant load application, further simplification is possible by omitting the remnant feedback sub-system, i.e. removing the induction coil launchers and associated parts.

For example, in application of ornithopter, aka flapping wings airplane, the load is air resistance and can be regarded as approx constant, then the customized pulse power supply can be maximally simplified. In latter description of other related inventions, this new kind of aircraft will be discussed in detail.

Someone may wonder why to use a quartet of dielectric blades, it is because that symmetrical structure claims best mechanic stability. In fact, it is also workable even reducing to duet structure, as there is full redundancy in the quartet design.

What if the electromagnetic induction coil launchers are replaced by water explosion?

Our current science community seems to believe overunity will occur! At least the famous physicist Dr. Peter Graneau thinks so.

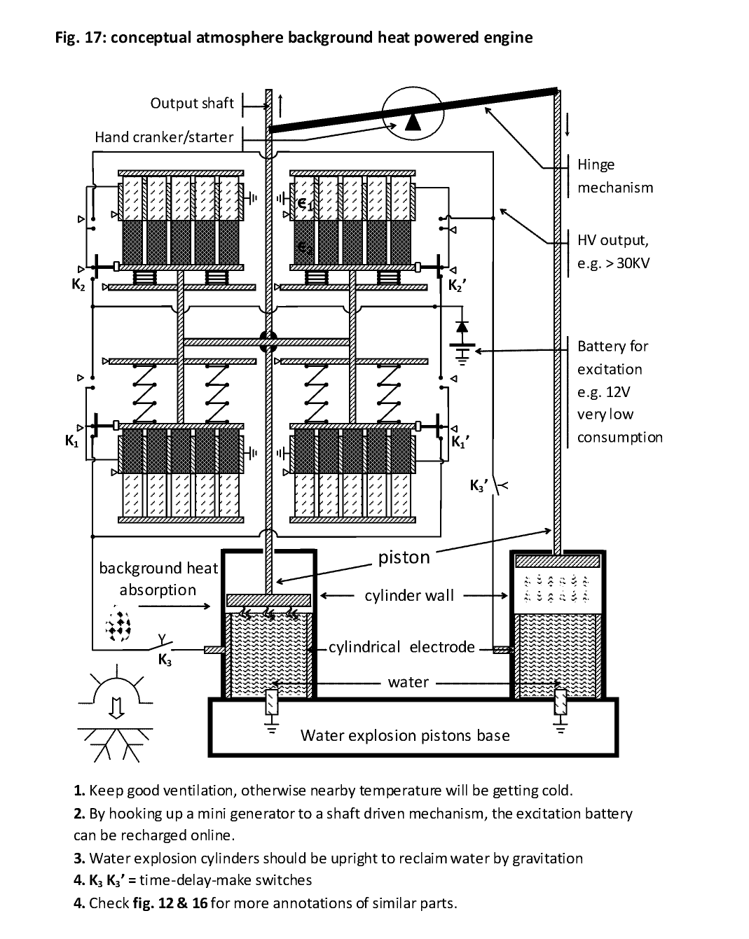

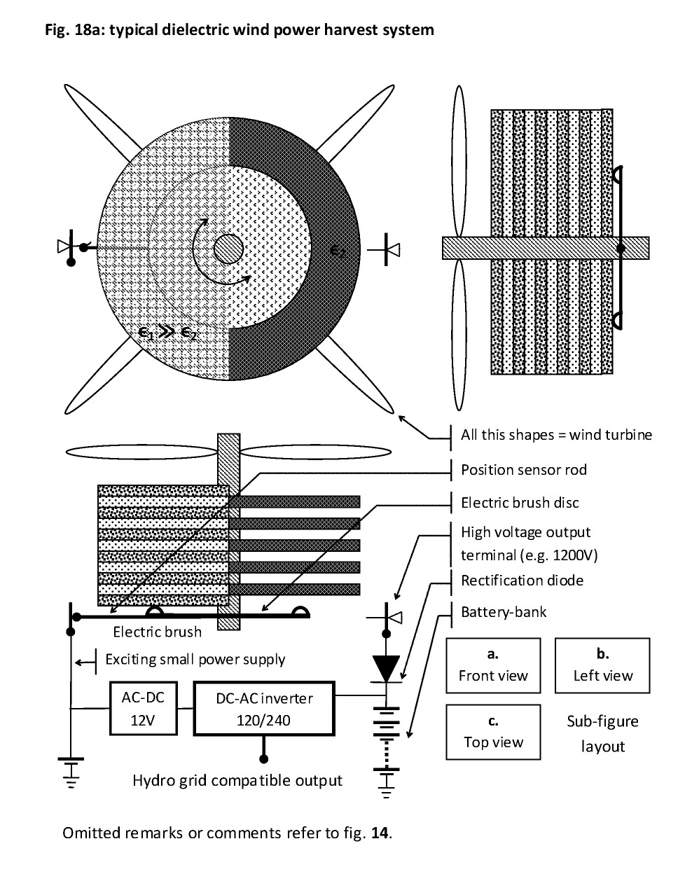

Assume overunity comes true, and then a conceptual design can be obtained by minor modification upon the previous invention. FIG. 17 is just such a proposed overunity machine that could harvest ambient background heat into useful mechanic energy.

Of course, the fuel consuming engine is no longer needed in this conceptual embodiment, but it does need initial crank to start.

Because overunity is always controversial, until a workable prototype at hand, I still need work hard to prove it, so I may not claim patent rights for it at present time.

Anyhow I will describe it in latter paragraphs for satisfying reader's curiosity.

Extended Invention #5—Dielectric Hydraulic Oil Bi-Role Involved High Voltage Generator

In fact, all hydraulic fluids are dielectric materials, e.g. for the regular mineral oil, the dielectric constant is about 2.25, as well as 6.25 for this special variety with flame retardant property: isopropylated triaryl phosphate (IPPP).

When the fluid is used as one of two dielectric media, as well as it also functions as power transfer agent, it is referred to bi-role, and of course, the counterpart medium must be solid in this case.

If oil is used as ∈₁, i.e. its dielectric constant is greater than the solid medium, then the high voltage is only available while the solid medium is inside the capacitor, vise versa.

FIG. 16c shows a hydraulic oil bi-role involved high voltage single shot generator. This design is recommended for the low ratio ∈₁/∈₂ configuration, such as ratio 2 to 30, then the handle should be operated many times to reach a decent high voltage.

In sub-FIG. 16c-i, once switch K is turned on for enough time, the battery will recharge the capacitor for excitation when ∈₂ is the insider, and then repeat push-pull operation many times as if it a handy inflator for bicycle tires, the gained high voltage is then ready for use.

The output voltage is gradually increased stroke by stroke, and it is getting gradually hard and hard to operate the handle, as the trend curve shown in FIG. 5.

After nth stroke, the accumulated voltage obeys this formula Vₙ₋ₚₑₐₖ=V₁*(∈₁/∈₂)^{(n+1)/2}, where V₁ is the initial excitation voltage.

This design is good for mobile application, such as portable X-ray generator.

From the view of engineering, hydraulic system should be outfitted with a reservoir tank, however, for this hand tool, it is okay to submerse the capacitor under bulk oil, and trap some air space over oil, also a breather is needed to balance inner air equivalent to the displacement volume of partial shaft.

The top surface of slice combiner, aka blade combiner, is beveled for better oil shedding.

Sub-FIG. 16c-ii shows an external hydraulic pump driven high voltage generator, and it is good for high ratio of pairing media dielectric constants, and can be used in mode of either single shot or periodic shots.

This variety module should be used as a hydraulic component just like a hydraulic cylinder and its host system should be outfitted with oil tank, pump, and solenoid valves for convenient control.

Two ports with hose fittings are needed for 2 displacement directions.

The slice combiner is drilled with some holes for easy displacement of oil trapped between dielectric blades when outside of capacitor.

Extended Invention #6—Dielectric Wind Power Harvest System

Conventionally and technically, the wind energy harness system relies on conversion of electromagnetic energy, and permanent magnet is always preferred in this application.

As an alternative invention, the technology of dielectric high voltage generation can be used in this application.

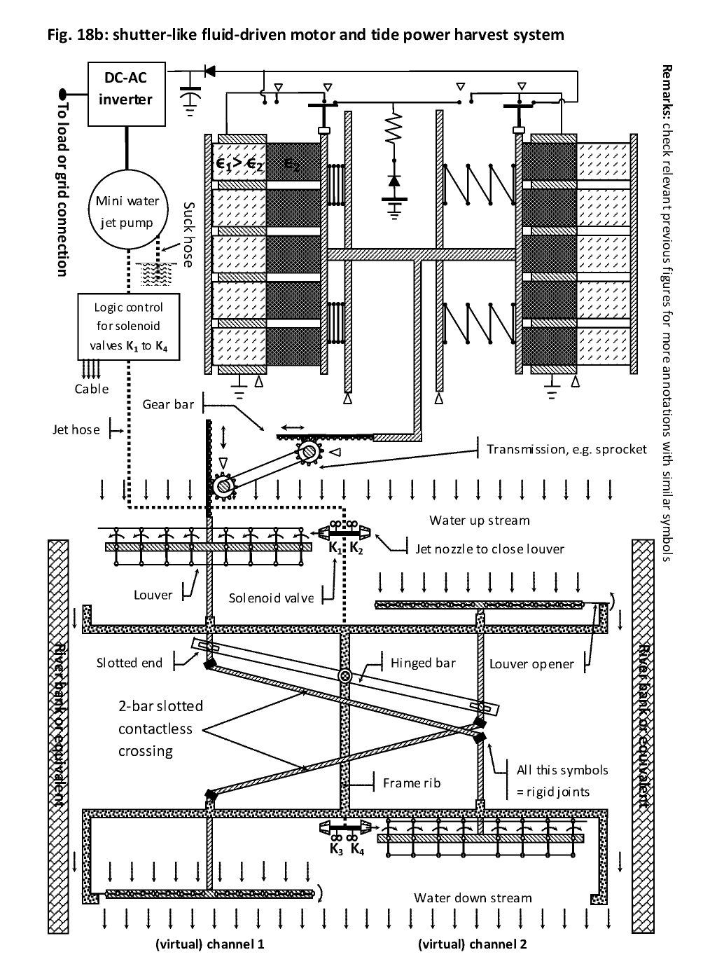

FIG. 18a shows a basic dielectric wind power harvest system where 3 orthogonal perspective views are drawn and abc-numbered for front (a), left (b) and top (c) views.

It comprises dielectric circular blade rotor, electric brush plus its carrier disc, position switches, turbine blades, battery bank, rectification diodes, DC-AC, AC-DC converters.

Because dielectric transformer favors high voltage, so that the energy storage battery bank should be wired in series, and the working voltage may reach thousands volts.

The electric field excitation voltage can be as low as the regular lead acid battery cell 12V, but does not have to be so, because higher excitation voltage may better match the wind condition in situ.

Luckily the excitation voltage just draws small electric current, so higher excitation voltage can be cheaply embodied with regular DC-DC circuit even only 12V accessible.

The capacitor's intermediate electrode plates should be wired in parallel mode so as to up the capacitance and to down the output voltage, because high voltage is difficult to be processed in transistor-based DC-AC or AC-DC converter circuit.

The DC-AC inverter enables the possibility of floating the wind power system on the commercial hydro grid.

Extended Invention #7—Shutter-Like Fluid Driven Motor and Tide Power Harvest System

The renewable energy is so plentiful, especially a great source of the running water hydrodynamic energy in all rivers and oceans. Nowadays, only high water head resources can be effectively utilized for hydro electricity, but the main resource is of low water head, and never well developed in prior arts, though some experimental tidal turbine projects are under research.

Here I present a shutter-like fluid-driven motor and try to apply it to the tidal power harvest system, of course, it applies to any rapid river too as showed in FIG. 18b. Shutter-like, aka louver-like motor, like as all regular board motors, is basically the planar type that receives mechanic energy directly by plain surface from energy carrying work fluid which current direction is vertical to the said surface, not by rotating blades as in traditional rotary turbines where fluid direction is never vertical to any blade; and usually the former can interface either a square or rectangular or even more complicated area with fluid power, but the latter only circular area.

For cycling work, all board motors including shutter-style, must run in reciprocal movement, and coincidently dielectric displacement generator is just in favor of such a mode, plus the flexibility of the said motor interface shape, so that their combination can be a good choice for harvesting natural fluid power, such as tidal energy.

Abstractly, the board motor absorbs direct current energy of unidirectional flowing fluid, such as running water, and converts it into alternating “current” or movement of rigid movable parts, i.e. reciprocating movement, and so, in a sense, it is a special DC-AC converter or inverter.

Run with the unidirectional flow produces effective work, however for recycling run, retraction is a must for next reciprocal cycle, but retraction is always counter-current, that is why the interfacing area should be reduced to almost zero by whatever feasible method for save of generated energy.

Hinging two parallel shafts in the central pivot point, two boards in pair can work in 180° phase difference that means one board's retraction can always be assisted by the other forwarding board pushed by fluid.

Further, combining the two pairs to quartet in cross linkage configuration as in FIG. 18b, the entire power interface area can be 100% utilized, if not then only 50%.

The quartet assembly virtually divides the whole stream to two quasi fluid channels, and if a separator wall is inserted in between, the quasi channels can become real channels.

The crossing linkage can be done by rigid joint of opposite boards in separate channels, thus, the boards in same channel always run in opposite direction.

To fix the space conflict, one of the two crossing bars can be slotted in middle quoted range, and the other bar runs through the slot.

For large planar motor, a single board can be hard to flip for toggle of interfacing area, because of either non-negligible toggle energy consumption, or not enough turn around room, that is why a shutter style motor is proposed, because every single vane of shutter is just a fractional area of the whole.

Compared with the full shutter board area, the power interface area of shutter rib-frame is almost negligible, so it is not necessary to flip the big size rib-frame, but just only toggling all vanes of the shutter is adequate.

Toggling the shutter is identical to say open or fold or close or unfold shutter in semantics, and where open shutter is mentioned, then it means fluid can passage the shutter and the shutter is in retraction stroke; otherwise the shutter is confronting fluid and in working stroke.

In the figure, closing or unfolding shutter is done by water jet, and opening or folding shutter by flange though water jet can be optional.

The timing of shutter toggle is important for efficient energy harvest, and solenoids can execute timing instructions from logic control module.

The water jet is produced by jet pump, and mini-size could be okay because of low energy consumption of toggling shutter. The absolute pressure of water jet is better to equal the fluid static pressure plus atmosphere pressure plus a threshold value that is determined by engineering conditions, because if too high then not economic else if too low unworkable.

In fact, toggling vanes of shutter should not be only credited to the jet power, but also the subsequent fluid power, because the yaw effect of fluid will assist and quicken the toggling transition, though the jet initialized and created the vane's non-equilibrium state, and that is also the reason why toggling energy is negligible.

For convenience of characterization, as the operating rationale aka working principle is well explained in context of all above description, I abstract and define such a rationale as fluid-DC-AC that means the unidirectional fluid pushes vanes that are alternatively changing orientation in parallel or vertical to stream by aforementioned mechanism so as to output mechanic energy during reciprocal movement. It applies to both planar and quasi planar vanes, such as plain board, shutter-like, or even umbrella-like.

By narrowing a waterway, the water current velocity can be increased significantly, so as to harvest more energy, as the illustrated river banks in the figure.

Coupling the fluid motor and generator is via transmission, such as sprocket mechanism, though direct coupling may work if the generator is well water-sealed and not big enough to block waterway and the run-length of dielectric blades is same with the motor reciprocating run-length.

As a rule of thumb, fluid motor is submersed in stream, generator is mounted on riverbed anchored platform over water body, and most applications work in shallow water except ocean application.

Last but not least, the duplex reciprocal dielectric generator, afore-interpreted in previous invention, is applied here, anyway minor modification is inevitable in output style that is changed from pulse power to regular AC power.

Now that super high voltage is no longer pursued, industrial or household voltage does prevail, so that the dielectric ratio is relative low, so low is the excitation voltage, and the integrated capacitor prefers to apply internal cells parallel wiring mode to get as high as possible grand capacitance.

A DC-AC inverter is wired to the output terminal of the dielectric blades module with a diode in series, and its output with proper amplitude and frequency is compliance with loads specification or standard of hydro grid connection.

Extended Invention #8—Mobile Medical X-Ray Source Made of Dielectric HV Generator

With the affordable DR (Direct Radiography) digital imaging panels promoting to market, portable X-ray source is highly desired in many applications, such as battlefield wound diagnosis, non-destructive detection, crystallography etc.

Conventional X-ray sources are so cumbersome that stimulates industry to try the downsizing of weight and dimension for the mobile applications.

The related prior arts all focus on the triboelectric technology, for instances:
1. Patent application: Triboelectric X-ray source filed in 2012 with application number US20130343526 by University of California
2. Patent application: X-ray generation devices and methods numbered as US20140369474 by Chiral Research Inc.
3. Patent: X-ray generator device, numbered as U.S. Pat. No. 8,938,048 by Tribogenics Inc.

As triboelectric generated X-ray usually is low energy about 25 KeV, the application scope is seriously restrained to a niche market.

In principle, the X-ray is generated by the bremsstrahlung (braking) effect of high kinetic electrons, and the normal photon energy is almost half of the electron peak energy.

Triboelectricity is physically unable to accelerate electron to a decent high velocity corresponded by in-house X-ray equipment with usual photon energy 150 KeV, but mere humble energy up to 50 KeV, that motivates further research on how to create decent HV for mobile application by whatever accessible non-electric power source in situ.

Peeling tape can also produce electrostatic high voltage, plus weak X-ray, just caused by stick-slip friction instead of rubbing.

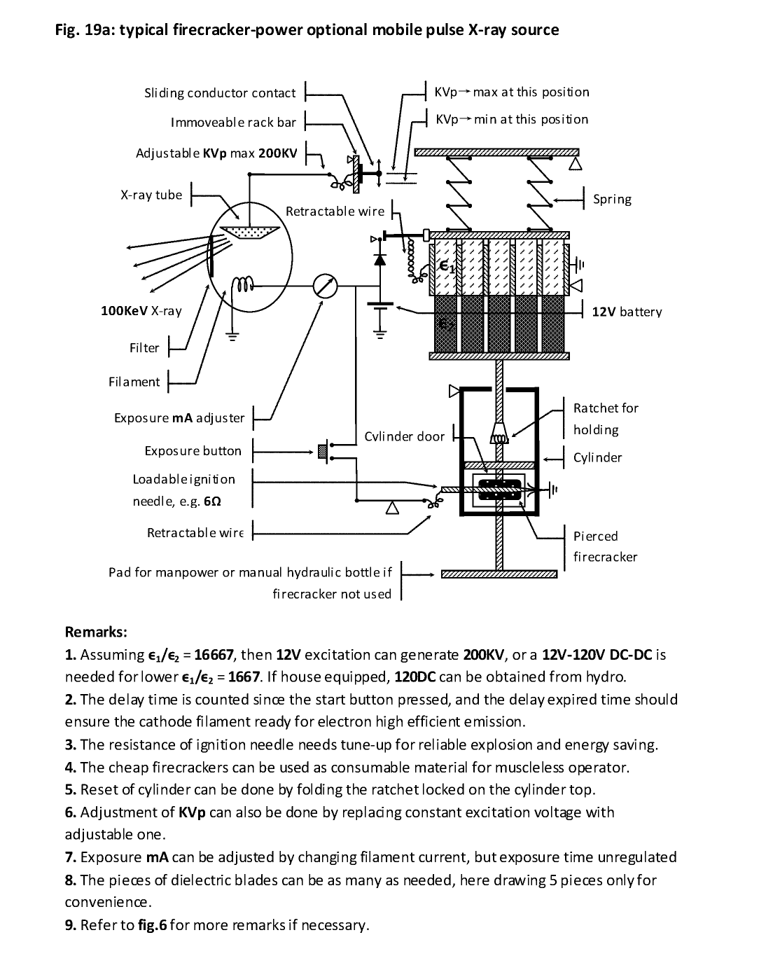

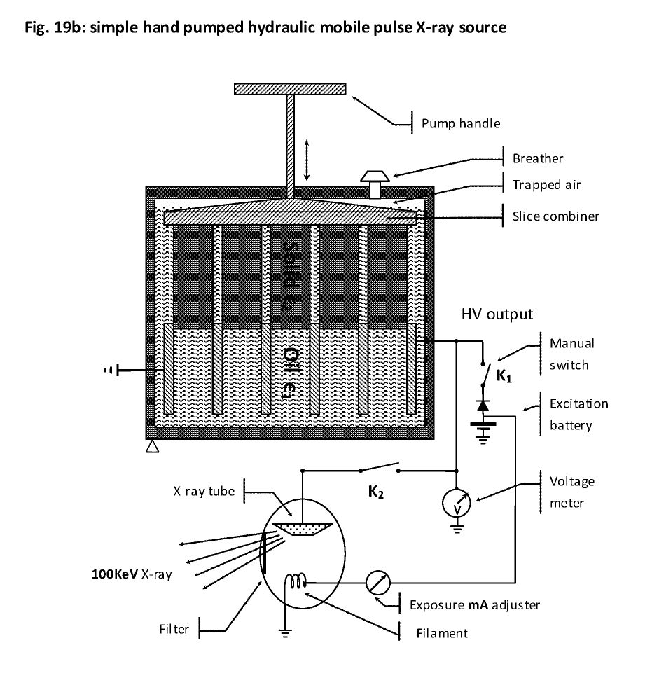

FIG. 19a shows my solution for such an application: typical firecracker-power optional mobile pulse X-ray source.

There are multiple choices for operation power where electric power inaccessible except battery in situ, such as manpower or with hydraulic hand tools, firecracker etc.

As an option for muscleless operator, the non-electric main power can come from cheap firecracker explosion that can drive the dielectric blades to generate whatever high voltage required, and every single firecracker can generate a decent energy X-ray flash, so as to image the object by DR panel in proper condition.

Assuming ∈₁/∈₂=16667, then 12V excitation can generate 200 KV at max, or a 12V-120V DC-DC is needed for lower ∈₁/∈₂=1667. If in-house use, 120 DC can be obtained easily from hydro power outlet.

The output peak voltage KVp can be tuned by adjusting the position of conductor contact point that detects whether the low dielectric permittivity medium is almost inside the capacitor.

The exposure mA parameter is adjusted by changing the filament current so as to regulate the emission amount of active electrons.

As to the exposure time, it is determined by the capacitor's total stored energy, hence not easy adjustable, but in fact, there is no significant impact, because digital radiography only need very short exposure time and is not picky to it.

Usually a few milliseconds good enough, and it is easy to meet by optimizing the pairing of capacitance and the equivalent resistance of X-ray tube.

The output high voltage should be completely discharged to X-ray tube before the dielectric blades reset, so that a ratchet mechanism is preferred to hold dielectric blades, then the locked ratchet must be manually folded to retract.

Usually a chest posterior anterior X-ray image will impose about 0.25 mGy dose radiation for adult patient, so it means even 1 J produced X-ray energy is too enough.

According the radiation theory, the X-ray production efficiency equals (7*Z*KVp*10⁻⁵)%, Z=anode atom number.

For the regular tungsten anode, Z=74, so if KVp=100 KV, then the efficiency is about 0.5%, it means that only a fractional energy is converted into X-ray, and most energy is dissipated as heat, so that 200 J total input energy is probably enough for once imaging.

For muscle manpower, 200 J may be not difficult to exert, if not, it should be okay to use hand pumped hydraulic bottle.

For muscleless operator, this design provides optional power of firecracker explosion.

The consumable firecracker is pierced by a resistor needle and inserted inside the cylinder. When the exposure button is pressed down, the needle is instantly heated to critical ignition temperature of firecracker, then explosion shockwave pushes the dielectric blades until held by ratchet and high voltage output is generated as well as X-ray tube flashes.

As to the synchronous control of DR panel, it is out of hither scope.

The resistance of ignition needle needs tune-up for reliable explosion and energy saving, e.g. 6Ω, then ignition power is 6*12=72 W.

Imaginably explosion of firecracker is very load, but the cylinder can muffle some noise. The door of cylinder is used for firecracker loading and exhaust gas escape.

To estimate the overall size, it relies on what dielectric materials are used and the desired max pulse energy and service factor.

For example, if the high energy density AF45 of max 38.5 J/cc is used and 1 KJ max pulse energy, considering service factor 10, then the volume of capacitor alone can be calculated by {1000 J/(38.5 J/cc)}*10=260 cc, further the dual dielectric media combination results in doubling of volume, again the intermediate electrode plates will double the volume too, so at last total volume 260*2*2=1040 cc, i.e. circa 10 cm*10 cm*10 cm if cubic shape, though flat block may be better for capacitor.

In addition, the explosion cylinder, manual pad, battery and X-ray tube all contribute to the grand total of volume. Even all those factors considered, the complete system is still reasonably portable as per the given estimation of volume and weight.

This design is intended to generate wanted high voltage in one stroke only for instant radiography, and that is why it prefers to a high dielectric ratio of pairing media, plus possible greater labor.

However, when time is not emergent, the wanted output can be accumulated during a series of strokes, so that the dielectric ratio of pairing media can be quite low, and media can be easily chosen from regular cheap materials, such as nylon, oil, Teflon, Mylar, Kapton, etc.

As the driving force is gradually increased in a series of strokes, so that easy hand operation is feasible, and regulation of output is simplely by watching the read of voltage meter while stroking until the wanted voltage appears.

For example, given the dielectric pair of Mylar and IPPP fire-proof hydraulic oil, then we have ∈₁=6.75, ∈₂=3.2, ratio ∈₁/∈₂=2.11, excitation V₁=12V, the wanted V₂=200 KV.

Solving this equation:

12*(2.11)^{(n+1)/2}=200000,

results in solution of stroke sequence number n={2*log(200000/12)/log 2.11}−1=25.

FIG. 19b is just a variety design for portable X-ray source that can embed such a hydraulic bi-role involved multiple hand-stroke single shot high voltage generator.

This design offers max flexibility for any operator, such as high or low voltage for battery, excitation switching, exposure high voltage adjusting, exposure current, X-ray flash triggering, manual or pedal stroking, etc.

Extended Invention #9—Pulse Propeller for the Vertical Takeoff Aerial Vehicle

The aerial propellers in my inventions can mechanically either be the umbrella-like or planar shape (synonymous designations include board propeller, panel propeller).

The propulsion force usually comes from a short time acting powerful energy release, such as pulse electromagnetic energy discharge, or explosion driven mechanic thrust.

Dielectric high voltage generators can accumulate the absorbed energy to produce a high power electric pulse, and such a property can be employed to propel an aerial vehicle via special propeller.

Just like the webs of duck feet or bird wings, human beings have struggled for many centuries to experiment flapping-wing aircrafts, or ornithopters that can vertically takeoff, but still failed to commercialize it.

Once upon commercialization of ornithopters, humankind will benefit in many aspects, e.g. affordable personal aerial commuting, remote internet service, goods shipping, etc.

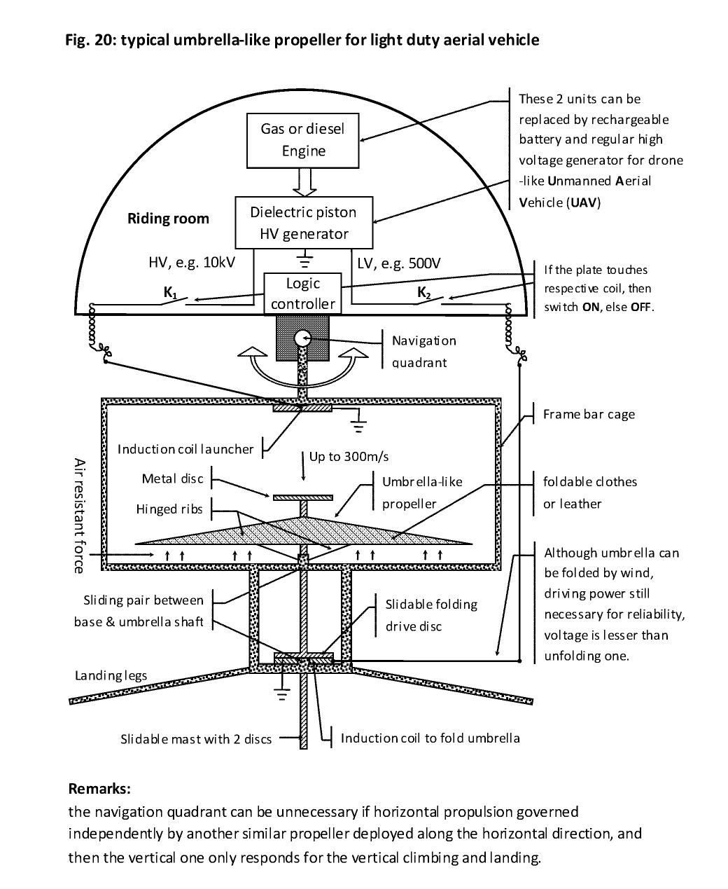

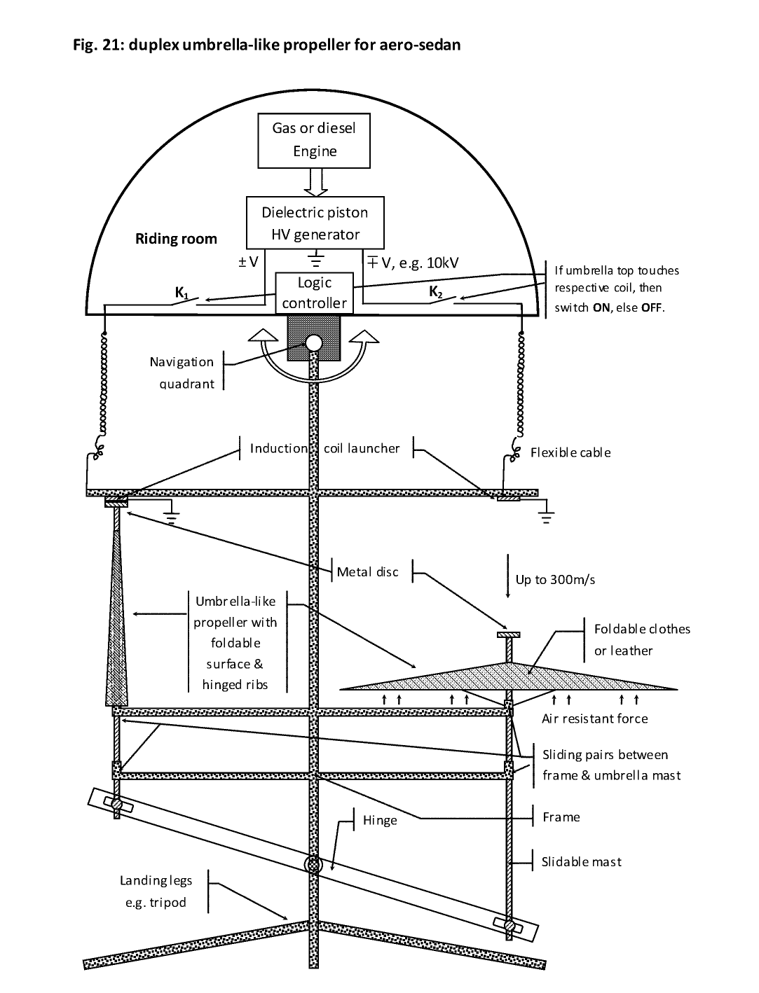

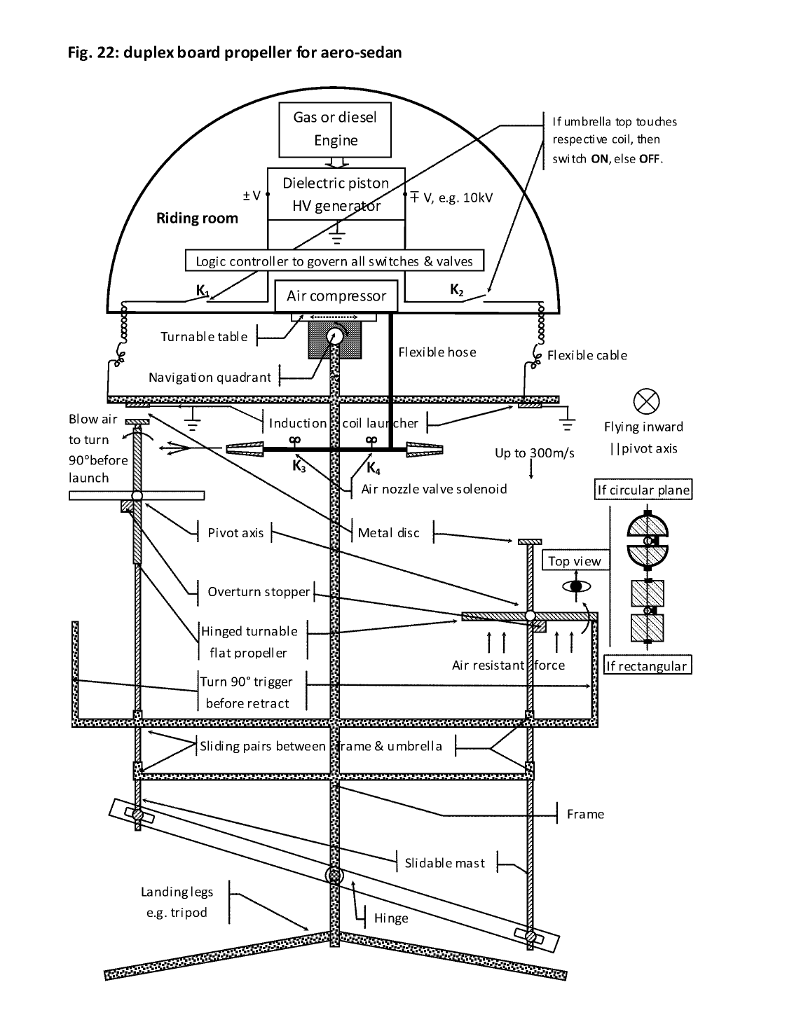

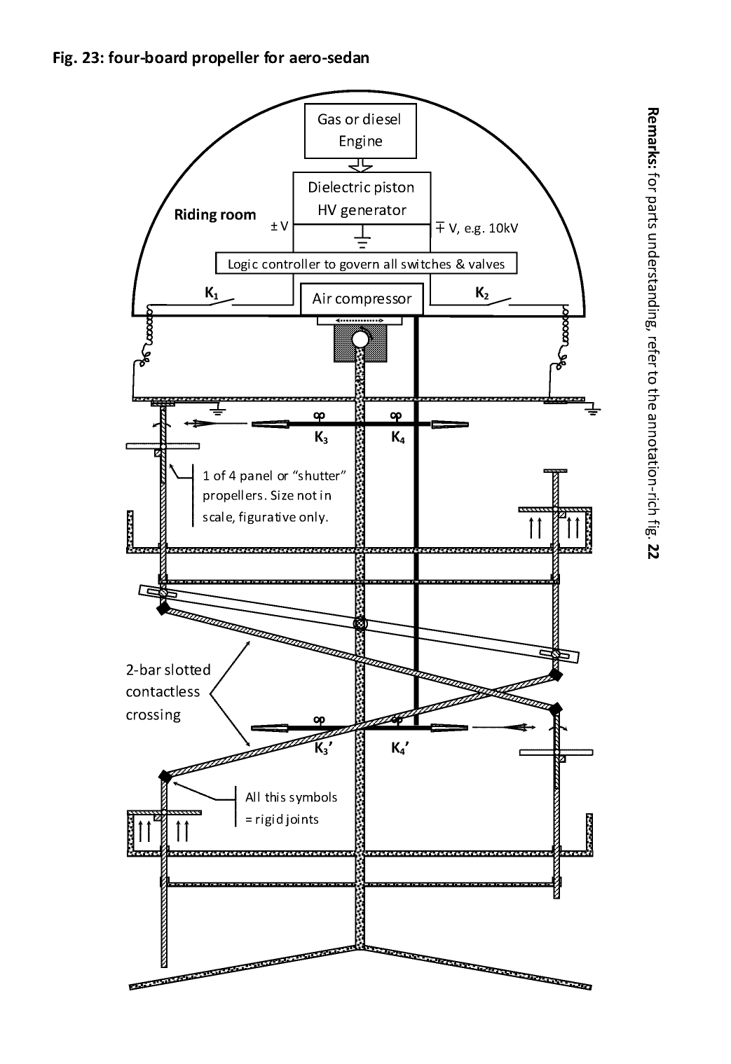

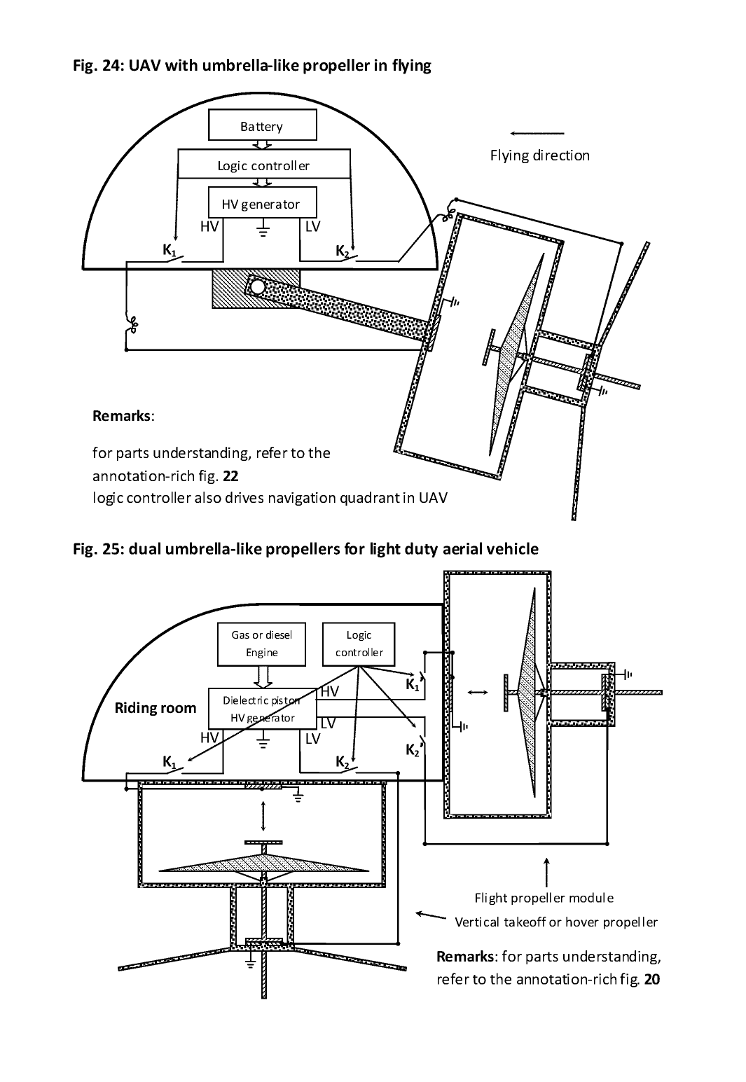

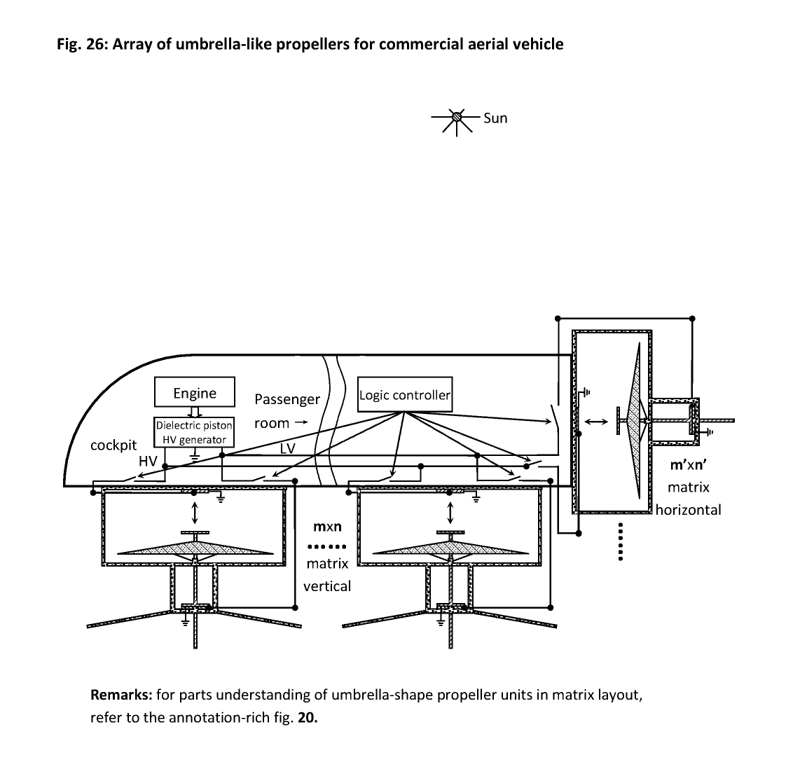

I propose the umbrella-like propeller that can perfectly fit the high voltage power supply made of dielectric blades displacement module, as is in FIG. 20.

By discharging high voltage in capacitors to a base-fixed disc-shape coil that contacts with a metal disc, such as aluminum disc, the huge current in the coil will induce a very strong magnetic field, and the induced eddy current in the metal disc will generate a matchable repelling magnetic field, so as to launch the metal disc in very high velocity.

For example, for a 10 KV voltage charged capacitor with 2.2 KJ, experiments show that the pulse discharge can accelerate a 4 ounces projectile to about 160 m/s initial speed, or if driving a realistic aerial vehicle of gross weight 200 kg, it may theoretically lift about 2200/(200*9.8)=1.12 m for a single pulse discharge.

According to aerodynamics, for 50 m/s typhoon wind speed, the pressure of facing surface can reach about 150 kg/m², and roughly proportion to the square of wind speed. That means 1 square meter umbrella with high enough speed of treading air may levitate a regular adult plus reasonable weight of driving module.

That higher the initial speed of umbrella, the stronger the propelling force, so by optimization of design, a proper umbrella area can be determined.

After umbrella full is unfolded and aircraft is pushed some distance, it should return to the folding status for next propulsion. Luckily the moving vehicle itself can help to retract the umbrella, and fold it, however, driving power is still necessary for reliability, though the applying voltage to the folding launcher no longer as high as unfolding voltage. This can be done by the same electromagnetic mechanism, just acting on the opposite position under umbrella.

Sometimes the umbrella top needs to keep in touch with the launcher coil for awhile if inertial energy enough to maintain flight, but gravitation always droops it though the wind resistance can fold the umbrella, so in order to overcome the gravitation, a proper auxiliary permanent magnet may be needed to secure the folded moment, despite of undrawn in the figure.

The power source can be a regular gas or diesel engine, and the engine usually drives a rotary dielectric replacement high voltage generator with 2 output terminals marked as HV and LV in figure.

The engine can also drive a hydraulic pump first, and then let the hydraulic system drive a reciprocal dielectric replacement voltage generator via a dual-action hydraulic cylinder.

If the dielectric displacement voltage generator is the type of liquid-solid dielectric pair with hydraulic oil bi-role involvement, then no need of the dual-action hydraulic cylinder.

HV output is used for umbrella unfolding that pushes vehicle in desirable direction, and LV for folding umbrella propeller.

When the top disc of umbrella touches the launcher coil, the switch K₁ is turned on, high voltage discharge occurs, the umbrella pushes air quickly, hence propelling force accelerates vehicle in opposite direction of fanned air.

When folding disc touching the folding coil, switch K₂ is turn on, the umbrella changes direction and is folded under wind pressure, until next propulsion to be ready.

The whole propeller module is hinged to base of riding room, and navigation can be at least done by swinging the propeller.

To have more payloads, all parts, including landing legs, the respective material and size should be well balanced.

In fact, for mini unmanned aerial vehicle, engine can be replaced by rechargeable battery, even the dielectric HV generator can be replaced by regular oscillation and rectification HV generator.

Almost all engines in market are the type of rotary, however if the type of reciprocal fuel engine is accessible, though not good pulse power, it may still be possible to directly drive the umbrella, just with a large degradation of linear velocity because piston's speed of most internal combustion engines is usually at max about 20 m/s which is far inferior to the pulse jerk propelled by electromagnetic catapult, but increasing area of umbrella can offset the degradation, and in turn, increase of volume and gross weight.

FIG. 21 is a modification to previous design. It features dual umbrella drive, so its duty performance can be improved.

FIG. 22 is another modification to previous design. It features dual planar drive instead of umbrella, and the propeller can be either circular plane or rectangular plane, its control is more sophisticated than the umbrella type.

FIG. 23 is a quartet modification based on FIG. 22, and its air treading area is doubled. Although it is implemented by rigid cross-joint between top duet and bottom duet, if fact, toothed bar gear transmission or other means can also do.

Usually the quartet design creates two quasi air channels where mutual interference may exist, but no significant negative effect, as long as there is proper separation distance between the channels.

With greater separation of the channels plus independent arbitrary control for all four wind boards, the quartet propellers can even perform steering and reverse, though no need of reverse and other main steering means always available.

The big size of wind boards may motivate the replacement with shutter-like propellers, and such a variety is equivalent to slice the whole board into a plurality of small pieces that are collectively manipulated, so as to reduce flipping turn-around space, as well as to take advantage of lower toggling energy and unturnable shutter ribbed frame, though further modification upon open or close of shutters is necessary.

This quartet propeller assembly can also be abstracted as a general model that can be shared by not only propellers but also future conceptual design of fluid pumps, as long as compact enclosed form factor and separator of channels are considered at least.

For convenience of characterization, as the operating rationale is well explained in the context of all above description, I abstract and define such a rationale as fluid-AC-DC that means the fluid air is treaded by alternating movement of propeller in alternating 90° differential orientation of windward or leeward so as to generate unidirectional direct fly. It applies to both planar and quasi planer propeller, such as plain board, shutter-like, and umbrella-like.

FIG. 24 shows an UAV in flying transition.

When the propeller's thrust creates useful work, the planar wind board should be vertical to the sliding mast, so as to have maximal surface to tread air, but when retract, the same board should be turned 90° so as to reduce wind resistance.

After the action of treading down air is completed, the turn-90°-trigger in the figure makes the board parallel to the mast, then ready to retract; and when the mast's top touches the coil launcher, before applying high voltage, the board should be turned vertical to mast, and this is done by switching on respective air blower valve solenoid.

During the board toggling to parallel the mast, retraction of propeller is made easy, but also it should not dampen the flying, so as the pivot axis of board should be parallel to the flying direction.

Such a requirement is marked in FIG. 22 by annotation “Flying inward∥ pivot axis” nearby a symbol of encircled cross, and the cross is figuratively like arrow-tail, so it can stand for the inward flying direction.

Above the navigation quadrant, there is a turnable table, and it is used for adjustment of wind board turnaround pivot, but for type of umbrella, no need of it.

Although the air compressor and control solenoids need consume energy, however it is acceptable insignificant energy and worthwhile.

In all aforementioned cases, the navigation quadrant can be unnecessary if horizontal propulsion is governed independently by another similar propeller deployed along the horizontal direction, and then the vertical one only responds for the vertical climbing or landing or hovering, as illustrated in FIG. 25.

FIG. 26 shows a great plan that features independent vertical and horizontal propulsion systems that are deployed in array of m*n and m′*n′ umbrella propellers respectively.

Array deployment can optimize the entire geometry configuration, for example, if 10 square meter umbrella area is required, then for single umbrella solution, the umbrella height could be 2 meters, in contrast, if 10 umbrellas array with 1 square meter each, then it can better match the chassis shape, e.g. in 2*5 array, and the height could be about only 0.6 meters.

Although only aerial propulsion emphasized hither, in fact, even marine vehicles can also adopt this new kind of propellers, just the property of pulse is then unnecessary or rising time of pulse can be very slow, because water body's density is far higher than air.

Extended Invention #10 in Wish List—Atmosphere Background Heat Powered Engine

Water is a magic medium, and high voltage pulse discharging to water can generate more unbelievably powerful explosion than the regular dynamite.

The pioneer of water explosion research is Professor Peter Graneau, and as early as about 2 decades ago, he not only found that the projectile water can reach supersonic velocity, but also that the arc-liberated energy exceeds electrical input energy!

Since the publication of his journal paper: “Arc-liberated chemical energy exceeds electrical input energy” in September 2000, many other researchers all over the world have successfully repeated their experiment and validated the anomalous energy generation.

He reported experiment results of overunity up to 1.6, or say, the output kinetic energy of water explosion can be 60% more than input electric energy of 12 KV discharge.

Some duplicate experiments by other scientists even gain 2-folds overunity.

In fact, such a pulse discharge is impossible to quickly electrolyze water into hydrogen and oxygen gas, because of too short time. This mystifies where the energy source comes from in the observed phenomenon. Although original author has tried to explain, my distinctive explanation can be seen is in the section of “science behind inventions”.

In FIG. 17, I propose an embodiment to take advantage of the anomalous energy: it could absorb ambient background heat to sustain the circulation of dielectric displacement voltage generation to water explosion to re-forcing dielectric displacement in positive feedback, thus outputs the balanced available mechanic energy.

For better mechanic equilibrium there used 4 capacitor modules, each horizontal duet working in parallel, and each vertical duet in opposite phase.

The excitation voltage can be provided by battery or multi-battery bank.

While the output shaft is pushed down to the lower critical point by whatever force, the top duet is ready to be excited by battery, simultaneously the lower duet's high voltage output is passing through the position switches to trigger water explosion in the left cylinder, then output shaft will change direction of movement, and the right cylinder piston will be driven down close to water surface by hinge transmission.

While the output shaft thrusts up by explosion in left water cylinder, and to the upper critical point, the lower duet is ready to be excited by battery, simultaneously the upper duet's high voltage output is passing through the position switches to trigger water explosion in the right cylinder, then the right piston will change direction of movement, and the left cylinder piston, i.e. the output shaft will be driven down close to water surface again by hinge transmission.

Because the water explosion releases more kinetic energy than the input electric pulse energy, so the positive feedback can sustain as long as the surplus energy is enough to recharge the excitation battery.

In hot climate, the surplus energy should be far more than the required recharge energy of excitation battery, and the balance can be output as workable mechanic energy.

By hooking up a mini generator to the output shaft, the battery can be recharged online.

Good ventilation should be kept, otherwise nearby temperature will be getting cold, and the work medium water may risk of freeze.

The water explosion two cylinders should be upright to reclaim water by gravitation, otherwise water pump may need.

The hinge mechanism can be simple end-slotted flat bar or toothed bar gear couple, and at the pivot position, a hand crank or starter is necessary for convenience.

For an effective water explosion, it is better to have a linear gradient of electric field by deploying a ring electrode and central invaginated solid electrode with max field strength from 3 MV/m to 60 MV/m (i.e. pure water's breakdown voltage), e.g. Dr. Graneau's experiment 3.8 MV/m for natural water.

Too high field far over breakdown may risk of nuclear reaction, though it sounds powerful, in fact, insignificant energy gain but harmful radiation, so as not worth of expensive safety investment.

The water impurity is tricky to achieve desired overunity. If too pure, then higher field is required, else if too salty, then heat loss will be significant, else proper field distribution should be solved via simulation software or experiment for given water condition.

### REFERENCE LITERATURE

Cited patents:

| | Filing | Pub. | | |
|---|---|---|---|---|
| Citing Patent | date | date | Applicant | Title |
| U.S. Pat. No. | 12 Jul. | 27 May | Sri | Electroactive |
| 7,378,783 | 2007 | 2008 | International | polymer |
| | | | | torsional device |
| U.S. Pat. No. | 16 Jul. | 4 Jul. | The Johns | Dielectric motors |
| 7,071,596 B2 | 2004 | 2006 | Hopkins | with electrically |
| | | | University | conducting rotating |
| | | | | drive shafts and |
| | | | | vehicles |
| US20140375150 | 7 Feb. | 28 Jun. | Reginald | High-efficiency |
| | 2001 | 2005 | Miller | compound |
| | | | | dielectric motors |
| US20130343526 | 9 Mar. | 26 Dec. | University | Triboelectric |
| | 2012 | 2013 | of California | X-ray source |
| US20140369474 | 12 Jun. | 18 Dec. | Chiral | X-ray generation |
| | 2014 | 2014 | Research | devices and methods |
| | | | Inc. | |
| U.S. Pat. No. | 27 Mar. | 20 Jan. | Tribogenics | X-ray generator |
| 8,938,048 | 2012 | 2015 | Inc. | device |

### CITED PUBLICATIONS

1, Smith et al. Alkali-free glass as a high energy density dielectric material. Materials Letters, 2009; 63 (15): 1245 DOI: 10.1016/j.matlet.2009.02.047
2. Zhou Lin et al. Design of a 5-MA 100-ns linear-transformer-driver accelerator for wire array Z-pinch experiments. PHYSICAL REVIEW ACCELERATORS AND BEAMS, Vol. 19, Iss. 3, March 2016; DOI: 10.1103/PhysRevArcelBeams.19.030401
3. Mazarakis, et al. Linear Transformer Drivers (LTD) for high voltage, high current rep-rated systems. In Proceedings of the 2010 IEEE International Power Modulator and High Voltage Conference, IPMHVC 2010, 5958297, pp. 69-74, 2010 IEEE International Power Modulator and High Voltage Conference, IPMHVC 2010, Atlanta, Ga., United States, 23-27 May. DOI: 10.1109/IPMHVC.2010.5958297

The inventions are described and expressed in well-illustrated figures and texts. All contain key implementing methods and procedures, and may be flexibly embodied in other specific forms or consisted of different working media configurations, even parameters configuration without departing from its spirit or essential characteristics.

All hither a host of inventions are based on a root invention: the method to generate either unlimited voltage or mechanic work by dielectric piston or blades displacement dependent on swap direction.

With respect to the independent right of the said root invention, all other derived or value-added inventions fall in class of combination innovations that overlay more or less proprietary innovative ideas on the common basic root invention.

All the illustrated embodiment plans are claimed as the at least protected scopes, and therefore, can be deemed as the topological “fingerprints” of the subject inventions.

Some figures come with embedded comments or remarks that also make properties of the said metaphorical fingerprints.

Any embodiment which schematic topology substantially matches any of the said figures is deemed as falling in the protection scope, or in other words, all minor changes which come within the meaning and range of equivalency of the claims are to be embraced within their scope.

For some simple combinations of inventions or just a conceptual wish, I even disclaim the incremental invention, such as the wind power harvest system, though its schematic plan is still presented in the collection of figures.

I also invite other inventors to research and develop more derived applications and combinatory innovations with respect to the said common root invention.

I claim:

1. The independent root invention of method that can generate either unlimited voltage or mechanic work by dielectric media combination piston or blades displacement in a variable capacitor configuration that enables voltage increase via the low permittivity medium replacing the charged high permittivity medium as well as enables mechanic work output via the high permittivity medium replacing the charged low permittivity medium. Such a method can also be nested stage by stage for pursuing extreme high voltage and pulse power.
This method can be primitively applied to the simple embodiment of single shot high voltage generator or multiple-stroke high voltage accumulator, such as Z-pinch pulse power supply or the hand pumped high voltage generator.

2. The method to realize nuclear fusor.
With respect to the claimed method 1, the increment invention is claimed for an innovative combination of inventions.
The method is by imposing extreme strong electric field on dielectric material that contains fuel elements, the said field strength should be a plurality of multiples of atomic inner electric field strength of reactant's elements, and is reached by an extreme high voltage generator that is made by the method 1.

3. The method and apparatus of dielectric motor.
With respect to the claimed method 1, the increment invention is claimed for an innovative combination of inventions.
It comprises single or a plurality of dielectric combination blades module(s) with well preset geometry recipe to characterize the motor's dynamism.
Further, 2 key actions are assured to occur circa the 2 tipping points by means of direct control of position switches or via logic controller with sensor acquisition: during the high permittivity medium fully inside the capacitor, a discharge action is taken, and during the low permittivity medium fully inside the capacitor, a recharge action is taken.
Further, the geometry recipe, i.e. the configuration of dimension parameters, can be determined as per the theory of dielectrodynamics described in prior sections.
Further, depending on the embodiment plan, the motor can work in mode of either simplex or duplex, with either reciprocal or rotary style.
Further, for better efficiency, the apparatus is classified into fixed load category, and variable category.
Further, the former comprises simple position switches with expectation that the motor's load can roughly consume all the cached electrostatic energy, and the latter comprises linear or angular position coordinate sensors and energy cache inductor and logic controller with expectation that the load is in variable. The said inductor is under control of a set of 4 switches which control logics can be abstracted as a pre-defined concept of KLP (Key Logic Package).

4. The method and apparatus to build pulse power supply with load adaptivity.
With respect to the claimed method 1, the increment invention is claimed for an innovative combination of inventions.
The purpose is to improve the pulse power supply's idling or partial idling performance.
The method is by reusing the remnant electrostatic energy to assist the mechanic energy provider after driving under-loaded consumer. The said assistance is executed by feeding the remnant electrostatic energy to an induction coil launcher or catapult, and in turn, the induced magnetic repellant force co-drives or tandem-drives the dielectric blades module(s) with mechanic energy provider in same transient direction.
It comprises: main mechanic energy provider, such as an engine, the frame module of a dielectric blades high voltage generator, 2 induction coil launchers, pulse distribution switches, and peripheral miscellaneous components.

5. The method and apparatus to harness fluid power.
With respect to the claimed method 1, the increment invention is claimed for an innovative combination of inventions.
It comprises a shutter-like fluid-driven motor, dielectrodynamic voltage generator, DC-AC inverter, jet pump, logic controller, mechanic transmission, solenoid valves, liquid hose, shutter-closing nozzles, and excitation battery.
Further, the said fluid-driven motor comprises: hinged bar, frame base with shaft sockets and shutter-opening flanges, and if simplex configuration, then 2 shutter-like propellers, 2 straight shafts; else if duplex, then 4 shutter-like propellers, and 2 shafts in blunt-Z-skewed shape.
Further, the said motor works in fluidic submersion and under the principle of the afore-defined fluid-DC-AC.

6. The method and apparatus of portable pulse X-ray source for mobile application.
With respect to the claimed method 1, the increment invention is claimed for an innovative combination of inventions.
It comprises a single shot non-electric powered high voltage generator with proper capacity of X-ray generation, X-ray tube, exposure current adjuster, and battery.
Further, the said non-electric power can be fed in from manual operation or firecracker explosion.
Further, for the modality of manual operation, it comprises a hand-pumped multiple-stroke high voltage generator with voltage meter for X-ray energy adjustment.
Further, the manual hydraulic high voltage generator comprises one solid dielectric medium, dielectric oil, frame casing, air breather, battery, and manual switch.
Further, the dielectric oil plays dual roles, both as dielectric medium and displacing force carrier.
Further, for the modality of firecracker explosion, it comprises cylinder, loadable ignition needle, exposure button, and cylinder holding ratchet, KVp adjuster.

7. The method and apparatus of ornithopter propeller system.
With respect to the claimed method 1, the increment invention is claimed for an innovative combination of inventions.
It comprises high voltage periodic pulse power generator, logic controller, propeller unit(s), induction coil launchers for folding and unfolding, a plurality of switches for pulse distribution, frame base with shaft sockets.
Further, it can be classified into 3 categories: umbrella-like propeller, board propeller, shutter-like propeller.
Further, for umbrella-like propeller, the driving surface is quasi planar, and the control of folding and unfolding is the simplest amongst all categories.
Further, for board or shutter-like propeller, the driving surface is planar, additionally, it comprises hinged bar, air compressor, nozzles, air hose, solenoid valves, and shutter rib-frame if shutter-like propeller.
Further, the propeller assembly works under the principle of the afore-defined fluid-AC-DC, and can be embodied in either simplex or duplex configuration.
